(19) United States
(12) Patent Application Publication
(10) Pub. No.: US 2026/0228443 A1
(43) Pub. Date: Aug. 6, 2026

(54) METHOD AND SYSTEM FOR IMPLEMENTING A GENERATIVE MACHINE LEARNING ARCHITECTURE FOR CONTEXTUAL MESSAGE GENERATION

(71) Applicant: Expedia, Inc., Seattle, WA (US)

(72) Inventors: Florian Hatt, Carouge (CH); Kaia Bonnet, Etrembières (FR); Ruben Agudo, Satigny (CH); Valentin Kardos, Collonges-sous-Salève (FR); Yatharth Katyal, New Delhi (IN); Stefano Casasso, Geneva (CH)

(73) Assignee: Expedia, Inc., Seattle, WA (US)

(21) Appl. No.: 19/044,444

(22) Filed: Feb. 3, 2025

(51) Int. Cl. G06F 40/35; G06F 16/335; G06F 16/338; H04L 12/18

(52) U.S. Cl. CPC G06F 40/35; G06F 16/335; G06F 16/338; H04L 12/1831

(57) ABSTRACT

A system can include one or more processors configured to store text strings corresponding to an application feature; obtain, via a network interface, one or more data files each comprising natural language content; execute, using a task agent, one or more large language models using the natural language content to generate an identification of the application feature; retrieve, using the task agent, the one or more text strings; filter, using the task agent, the one or more text strings; execute, using the task agent, the one or more large language models using the filtered one or more text strings, the identification of the application feature, and an identification of the first entity as an input; and transmit a message for presentation at a computing device, the message containing the visual representation of the input.

### TECHNICAL FIELD

Embodiments and aspects of the present disclosure relate, generally, to systems and methods for generative machine learning architecture message generation. The generative machine learning architecture can be configured to receive data files containing natural language content and select text strings that correspond to an application feature based on the natural language content of the data files. The generative machine learning architecture can use the selected text strings to generate a contextually relevant message for presentation at a computing device.

### BACKGROUND

Generative machine learning models, such as those based on deep neural networks or transformers, have the potential to significantly enhance various enterprise applications, including automated content creation, predictive analytics, and customer service. However, their integration into enterprise-based systems presents several challenges. For example, generative machine learning models may demand substantial computational resources, which can strain existing infrastructure and lead to performance bottlenecks. Additionally, generative machine learning models may be used to automate many processes and simulate human interactions. However, such automation may come with its own difficulties because generative machine learning models often generate general responses without contextual details. Generative machine learning models are likely to avoid contextual details to avoid hallucinations, but may potentially compromise the immersive quality of simulated interactions in the process.

### SUMMARY

In one aspect, the present disclosure relates to a computing system. The computing system can include a network interface and at least one processing circuit coupled to the network interface. The at least one processing circuit can include at least one processor and at least one memory. The at least one memory can store instructions that, when executed by the at least one processor, cause the at least one processor to: store, in a database, one or more text strings corresponding to an application feature and generated based on the use of the application feature by at least one entity; obtain, via the network interface, one or more data files each comprising natural language content and generated based on a different communication interaction with a first entity; execute, using a task agent, one or more large language models using the natural language content of the one or more data files to generate an identification of the application feature determined for the first entity; retrieve, using the task agent, the one or more text strings corresponding to the application feature from the database using the identification of the application feature; filter, using the task agent, the one or more text strings based on at least one similarity between the first entity and at least one other entity associated with the one or more text strings; execute, using the task agent, the one or more large language models using the filtered one or more text strings, the identification of the application feature, and an identification of the first entity as an input to generate a visual representation of the input; and, transmit a message for presentation at a computing device of the first entity, the message containing the visual representation of the input.

In another aspect, the present disclosure relates to a computer-implemented method. The method can include: storing, by one or more processors in a database, one or more text strings corresponding to an application feature and generated based on the use of the application feature by at least one entity; obtaining, by the one or more processors, one or more data files each comprising natural language content and generated based on a different communication interaction with a first entity; executing, by the one or more processors using a task agent, one or more large language models using the natural language content of the one or more data files to generate an identification of the application feature determined for the first entity; retrieving, by the one or more processors using the task agent, the one or more text strings corresponding to the application feature from the database using the identification of the application feature; filtering, by the one or more processors using the task agent, the one or more text strings based on at least one similarity between the first entity and at least one other entity associated with the one or more text strings; executing, by the one or more processors using the task agent, the one or more large language models using the filtered one or more text strings, the identification of the application feature, and an identification of the first entity as an input to generate a visual representation of the input; and, transmitting, by the one or more processors, a message for presentation at a computing device of the first entity, the message containing the visual representation of the input.

In still another aspect, the present disclosure relates to a computing system. The computing system can include a network interface configured to communicate with at least one user device of a first entity, and at least one processing circuit coupled to the network interface. The at least one processing circuit may include at least one processor and at least one memory. The at least one memory can store instructions therein that, when executed by the at least one processor, cause the at least one processor to: store, in a database, one or more text strings corresponding to an application feature and generated based on the use of the application feature by an entity; detect a termination of a communication session with at least one user device associated with a first entity; responsive to the detection, identify a recording or a transcript of the recording of the communication session with the at least one user device associated with the first entity, the recording or the transcript of the recording comprising natural language content; execute, using a task agent, one or more large language models using the natural language content of the recording or the transcript of the recording to generate an identification of the application feature determined for the first entity; retrieve, using the task agent, the one or more text strings corresponding to the application feature from the database using the identification of the application feature; filter, using the task agent, the one or more text strings based on at least one similarity between the first entity and at least one other entity associated with the one or more text strings; execute, using the task agent, the one or more large language models using the filtered one or more text strings, the identification of the application feature, and an identification of the first entity as input to generate a visual representation of the input; and transmit a message for presentation at a computing device, the message containing the visual representation of the input.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1A is a block diagram of a system for implementing a generative machine learning architecture for contextual message generation, according to some implementations;

FIG. 1B is an example transcript and generative artificial intelligence model output generated based on the transcript, according to some implementations;

FIG. 1C is an example user interface showing an electronic message generated using the systems and methods described herein, according to some implementations;

FIG. 1D is an example user interface showing a list of recommendations of application features, according to some implementations;

FIG. 2 is a block diagram of a sequence for implementing a generative machine learning architecture for contextual message generation, according to some implementations;

FIG. 3 is a flow chart of a method for implementing a generative machine learning architecture for contextual message generation, according to some implementations;

FIG. 4 is another flow chart of a method for implementing a generative machine learning architecture for contextual message generation for a communication session, according to some implementations; and

FIGS. 5A and 5B are block diagrams depicting embodiments of computing devices that can be used in connection with the methods and systems described herein.

The details of various embodiments of the methods and systems are set forth in the accompanying drawings and the description below.

### DETAILED DESCRIPTION

For purposes of reading the description of the various embodiments below, the following descriptions of the sections of the specification and their respective contents may be helpful:
Section A describes embodiments of systems and methods for implementing a generative machine learning architecture for contextual message generation; and
Section B describes a computing environment that can be used for practicing embodiments described herein.

### A. Systems and Methods for Implementing a Generative Machine Learning Architecture for Contextual Message Generation

Generative machine learning has the potential to significantly enhance various enterprise applications. These models can automate complex tasks, provide insightful predictions, and create personalized customer interactions. However, their integration into enterprise-based systems presents several challenges. One major challenge is the substantial computational resources required by these models, which can strain existing infrastructure and lead to performance bottlenecks. Another major challenge is integrating the generative models to simulate human interactions, such as in a chatbot or automatic message generation ecosystem. Generating messages or responses that accurately simulate human interactions is difficult for generative machine learning models given their propensity to generate generic and accurate messages without the contextual nuance that typically accompanies human speech or language. Attempts to overcome this issue, such as implementing other models or using fine-tuning training of models, can incur excess computing resources because they involve extra processing of data and/or can result in hallucinations in generated messages. The high demand for processing power and memory to generate nuanced messages can impede real-time generation and processing, affecting user experience and operational efficiency.

The systems, computer-readable media, and methods described herein address at least the aforementioned technical deficiencies or problems. As described herein, a data processing system may do so by storing text strings indicating metrics (e.g., performance metrics) of different entities when using different application features (e.g., software add-in, plug-ins, application configurations that can be activated for accounts with the data processing system, promotions, etc.) and using a filtering technique to select from the text strings to use to generate messages using one or more generative models (e.g., large language machine learning models). For example, the data processing system can store, in a database, one or more text strings that correspond to an application feature. The text strings can be or include metrics (e.g. numerical, alpha, or alphanumerical metrics) that indicate performance of an application feature when used by different entities. The data processing system can obtain one or more data files that each include certain content, such as natural language content. The data files may be generated based on or to include recordings of video and/or audio communications sessions (e.g., virtual meetings and/or phone calls) between the data processing system or one or more users of the data processing system and other computing devices and/or users of the computing devices. The computing devices and/or users of the computing devices can be associated with, owned by, or employed by a first entity (e.g., an enterprise, a company, or an organization). The data processing system can use a task agent (e.g., an LLM-based software program) to execute one or more large language models using the natural language content of the data files to cause the large language models to generate an identification of an application feature that may be relevant to the first entity. The large language models may generate the identification based on a similarity between the natural language content in the data files and one or more aspects of the application feature.

The data processing system can use the application feature and characteristics of the first entity to identify text strings to include in a message. For example, the data processing system can use the task agent to query the database using the identification of the application feature to retrieve the text strings stored in the database that are associated with the application feature. The data processing system can use the task agent to identify entities that are similar to the first entity (e.g., above a threshold) and filter the text strings to identify the text strings that correspond with the identified entities. The data processing system can use the task agent to execute the one or more large language models using the filtered text strings, the identification of the application feature, and/or an identification of the first entity as input to generate a visual representation (e.g., an email, a chat response for a chat interface, or a notification) of the input. The data processing system can transmit a message containing the visual representation of the input to a computing device of the first entity. In this way, the data processing system can use a task agent to determine factual context for a generative model (e.g., a large language model) output. The generative model can generate the output without the use of excess processing power for fine-tuned training, without the use of a second model for extra pre-processing, and without querying a large group of data sources using retrieval augmented generation (RAG) techniques, which means the data processing system may generate the context-specific messages with reduced latency, with reduced processing requirements, with reduced hallucinations.

In some cases, the data processing system can use the systems and methods described herein to generate a context-specific message regarding a particular communication session. For example, the data processing system can detect termination of a communication session with a user device associated with a first entity. The data processing system can detect the termination of the communication session because the data processing system may be the host of the communication session, in some cases. Responsive to the termination of the communication session, the data processing system can use a task agent and one or more large language models to identify an application feature based on a recording or transcript of the communication session. The data processing systems can identify filtered text strings associated with the application feature using the task agent and the one or more large language models and generate a message based on the filtered text strings, an identification of the application feature, and an identification of the first entity. The data processing system can transmit the message to a computing device associated with the first entity for presentation. Accordingly, the data processing system can automatically generate context-specific messages based on individual communication sessions without using excess computing resources or incurring extra latency to provide extra contextual data in the messages. In this way, by using the termination of the communication session as a trigger, the data processing system of the present disclosure may only analyze certain communications with the data processing system such that processing power is utilized in only certain situations thereby improving operation of the data processing system as a whole by reducing the memory occupancy and processing power requirements. These and other features and benefits are described more fully herein below.

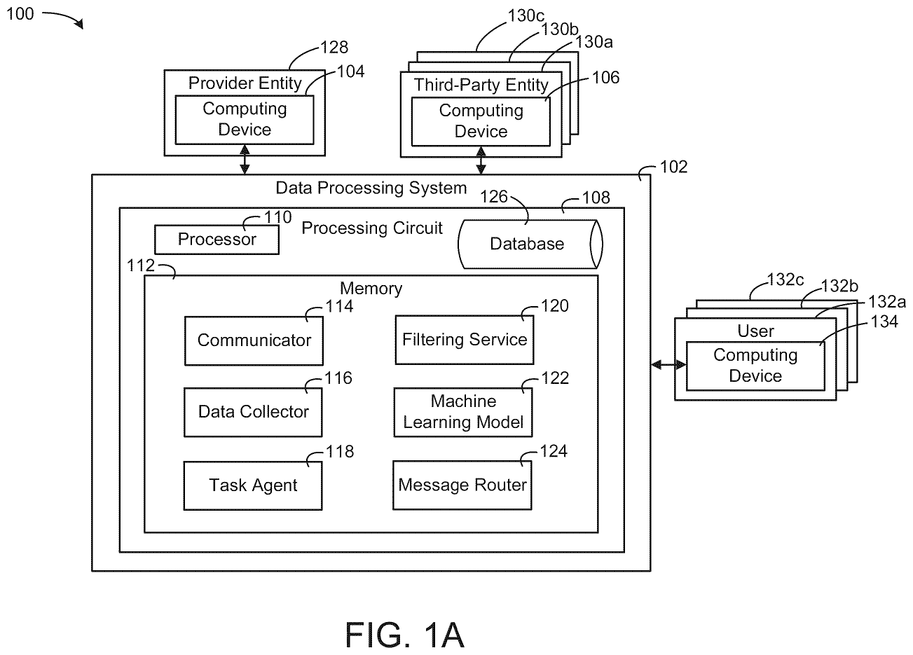

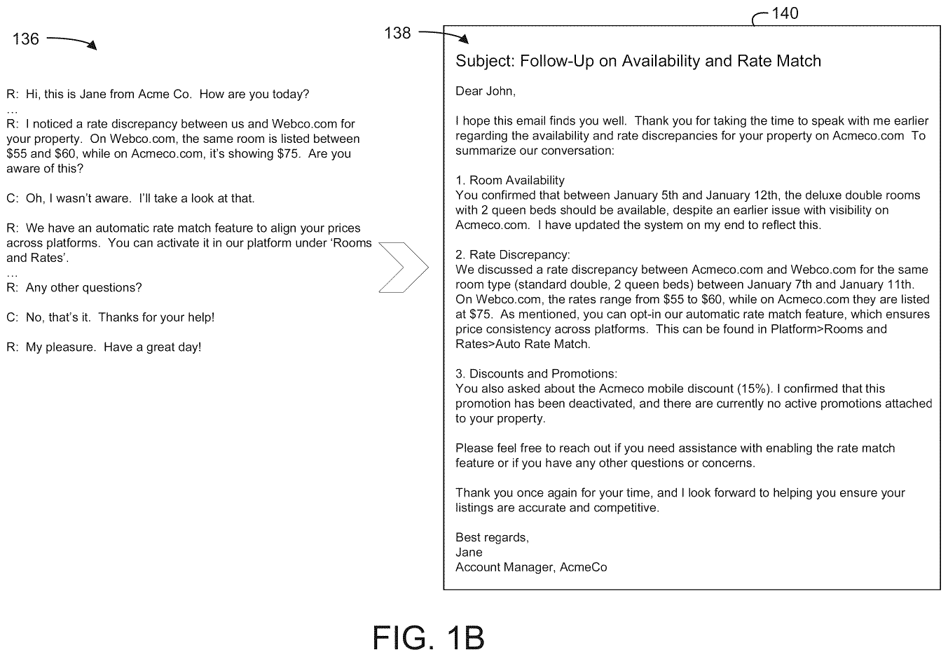

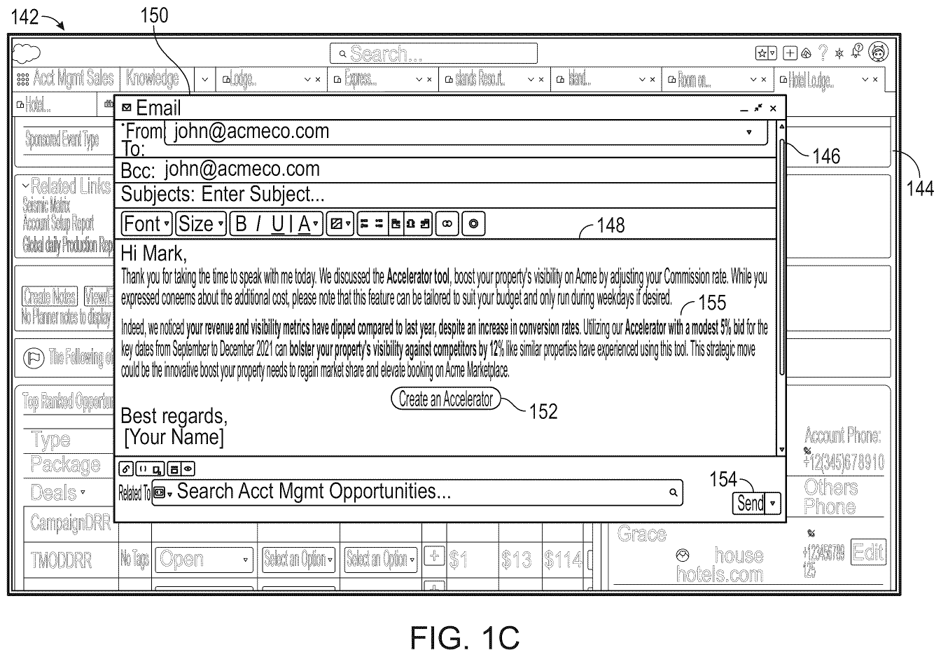

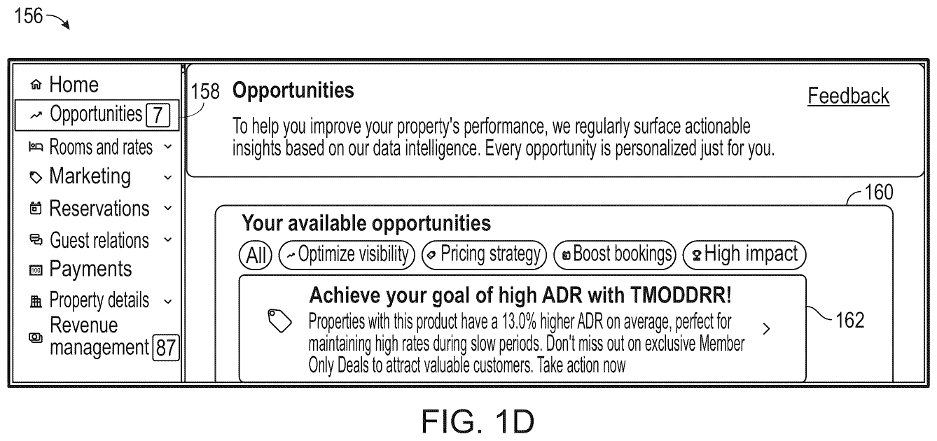

Referring now to FIG. 1A, a block diagram of a system 100 for implementing a generative machine learning architecture for contextual message generation is shown, according to some implementations. The system 100 may include a data processing system 102 (also referred herein to as a provider computing system), a first computing device 104, a second computing device 106, and a third computing device 134. The data processing system 102 can communicate with the computing device 104 and the computing device 106 over a network (e.g., a communications network) (not shown).

The computing devices 104 and 106 may each be or include one or more of any type and/or form of computing device or system, including a desktop computer, laptop computer, portable computer, tablet computer, wearable computer, embedded computer, smart television, set top box, console, Internet of Things (IoT) device or smart appliance, or any other type and form of computing device. The computing devices 104 and 106 may be used by users to communicate with each other and/or with the data processing system 102. While only two computing devices 104 and 106 are shown, it should be understood that a plurality of devices may be included in and/or used with the system 100. Computing device(s) may be referred to variously as a client, device, client device, computing device, anonymized computing device, or any other such term. The computing devices 104 and 106 may include display devices, at least one processing circuit having at least one processor and memory, and/or other circuitry. Client devices, computers, and/or computing devices may also be referred to herein as user devices.

Computing devices and intermediary modulators as described herein may communicate via any appropriate network, including local area networks (LANs), wide area networks (WANs) such as the Internet, satellite networks, cable networks, broadband networks, fiber optic networks, microwave networks, cellular networks, wireless networks, or any combination of these or other such networks. In many implementations, the networks may include a plurality of subnetworks which may be of the same or different types, and may include a plurality of additional devices (not illustrated), including gateways, modems, firewalls, routers, switches, etc.

The computing device 104 can be an internal user device relative to the data processing system 102. Internal user devices can be user devices that are owned and/or operated by a provider institution or entity 128 that owns and/or operates the data processing system 102. Internal user devices can be accessed by employees or other internal stakeholders of the provider entity 128. Internal user devices can be integrated into the network infrastructure of the provider entity 128 (or external, in some embodiments) and can be configured with specific security protocols and software tailored to the provider entity. Internal user devices can access a platform, which may be a virtualized environment, a website, a software-as-a-service (SaaS) environment, etc., that is provided or hosted by the data processing system 102. The internal user devices can access the platform using login credentials (e.g., a username and password) for the platform. In some cases, internal user devices can access the platform by executing a client application (e.g., a browser or an API configured to communicate with the data processing system 102). Internal user devices can facilitate secure access to proprietary systems, collaboration tools, and sensitive data, emphasizing control and compliance with provider entity policies. Applications executed by internal user devices to communicate with the data processing system 102 may be provisioned by the data processing system 102 to the internal user devices and/or downloaded and configured onto the internal user devices by the provider entity 128 that owns or manages the internal user devices. In some cases, the applications can be browsers that communicate with the data processing system 102 through a website hosted by or otherwise associated with the data processing system 102.

The computing device 106 can be an external third-party user device or computing system relative to the data processing system 102. External user devices can be owned and/or managed by third-party individuals or entities 130a-c (together, entities 130, and separately, entity 130) outside of the direct control of the provider entity 128. The third party entities may be clients, partners, or vendors. In the example shown, the third party entities may be/include lodging providers (e.g., hotel owner and/or operators, vacation rental owner and/or operators, etc.), airline providers, excursion and/or experience providers, and so on. The entities 130 can be or include enterprises, companies, or organizations. The third-party entities, via the computing system 106, may provide information regarding their offerings to the provider institution computing system 102. The computing device 106 can be a computing device that is owned and/or operated by the entity 130a. Each of the entities 130 can correspond to or be associated with one or more computing devices similar to the computing device 106.

External user devices can be used to interact with the provider entity 128's external-facing systems, such as customer portals or online services (e.g., websites). While external user devices may employ security protocols, such as authentication and access controls, external user devices can operate outside the network infrastructure of the provider entity 128. Applications executed by external user devices to communicate with the data processing system 102 may be provisioned by the data processing system 102 to the external user devices and/or downloaded and configured onto the external user devices by the provider entity 128 that owns and/or manages the external user devices. In some cases, an application of an external user device can be a browser that communicates with the data processing system 102 through a website hosted by or otherwise associated with the data processing system. External user devices may employ measures such as secure authentication protocols and data encryption to safeguard interactions between the data processing system 102 and the external user devices to protect the data processing system 102 and/or network infrastructure from unauthorized access or breaches.

The data processing system 102 may be managed by, controlled by, owned by, and/or otherwise associated with the provider institution or entity 128. The provider institution or entity 128 may be a provider of goods and/or services. In the example shown, the provider institution 128 may provide travel services and, particularly be an online travel agency (OTA). As such, the provider institution, via the provider computing system 102 may provide the ability to make lodging reservations, make airline reservations, generate itineraries, provide trip suggestions, and so on. The provider institution may provide such services through the data processing system 102.

The data processing system 102 can be configured to present (e.g., via the platform hosted by the data processing system 102) content uploaded by different entities 130, whereby the content is received by the data processing system 102 over the network from the entity computing system(s) associated with the entity(ies) 130a-c. As mentioned above, the entities or partners 130 may be third parties relative to the provider entity 128. Given the provider entity 128 may be an OTA, the entities 130 may be lodging providers, airline providers, vacation rental providers, excursion/experience providers, and so on. The entities 130 can be or include partners of the provider entity 128. The content can include images, videos, audio, a combination thereof, etc. In some cases, the content can correspond to different deals, offerings (e.g., a two-day hotel stay offering), and/or other types of listings associated with the entities 130. The data processing system 102 can present the content in list form (e.g., by presenting thumbnails with defined details of the listings, such as the price, time frame, and/or any other defined details of the listings) to users, such as in response to queries. The data processing system 102 can operate a search engine that is configured to identify relevant content to the queries and present the content in a list on a user interface of the computing devices 106 and/or 134. Users can view or interact with the content in the list to view pages dedicated to this content. For example, users can select different pieces of content that are shown via the platform, and the data processing system 102 can present pages associated with the pieces of content in response to the selections. The entities 130 can upload the content over time to the platform using accounts that the entities have with the platform.

In one example implementation, the computing device 134 can be a user, particularly a traveler user device, that a user (traveler or other user engaging with the platform of the data processing system 102) can use to access the platform provided by the data processing system 102 to make purchases from travel listings posted on the platform by the entities 130. Computing devices such as the computing device 134 can be external user devices and may be owned and/or managed by individual users 132a-c (together, users 132, and separately, user 132). The users 132 can access the computing devices to view different travel postings by the entities 130 on the platform provided by the data processing system 102. The computing devices accessed by the users 132 can communicate with the data processing system 102 to access the platform provided by the data processing system 102 via an application or API, such as a browser or an API configured to communicate with the data processing system 102. The users 132 can purchase the listings on the platform through accounts that the users 132 have with the platform.

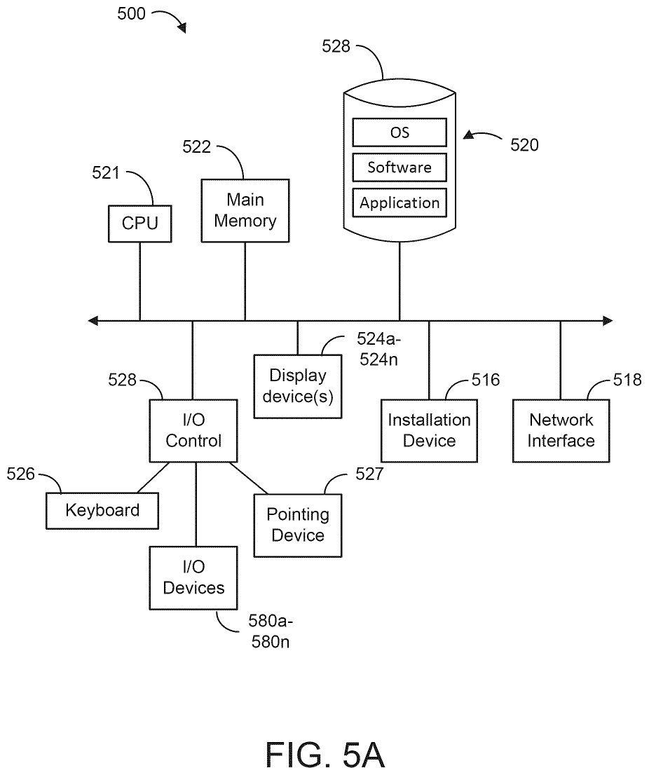

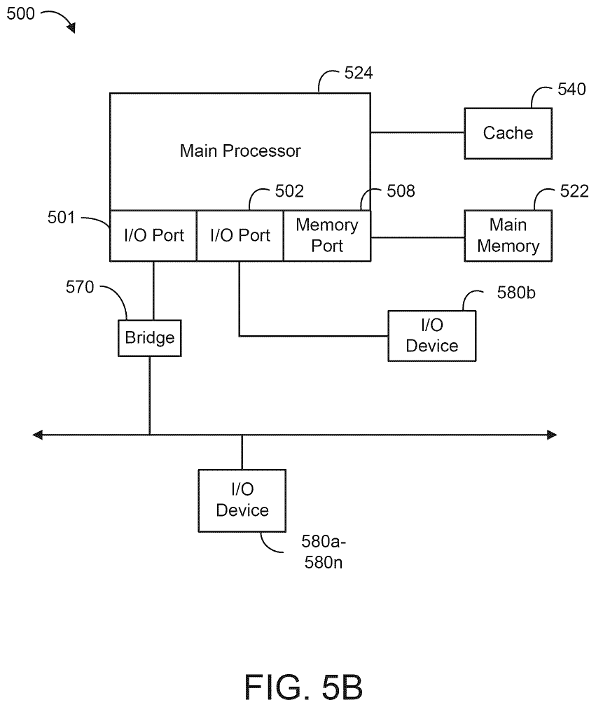

The data processing system 102 may include at least one processing circuit 108 having at least one processor 110, at least one memory 112, and at least one database 126. The processing circuit 108, the processor 110, the memory 112, and/or the database 126 can correspond to or be the same as components described with reference to FIGS. 5A and 5B. In some embodiments, the data processing system 102 can operate in the cloud as one or more cloud servers. The data processing system 102 can communicate with the computing devices 104 and/or 106 or any other computing device over a network (e.g., a synchronous or asynchronous network).

The memory 112 may include a communicator 114, a data collector 116, a task agent 118, the filtering service 120, one or more machine learning models 122, and a message router 124. The memory 112 may include any number of components. In the example shown, the communicator 114, the data collector 116, the task agent 118, the filtering service 120, and the message router 124 are structured as sets of logic that are selectively accessed and executed by the at least one processor 110. In other embodiments, at least one of the aforementioned components are structured as separate circuits and, as such, may have the structural definition described herein with respect to “circuit.”

The communicator 114 can be structured as a set of instructions or logic that is executed or performed by one or more servers or processors (e.g., the processing circuit 108), in some embodiments. The communicator 114 may be or include an application programming interface (API) that facilitates communication between the data processing system 102 and other computing devices, such as the computing devices 104, 106, and/or 134.

The communicator 114 can establish communication connections with computing devices (e.g., the computing devices 104, 106, and/or 134). The communicator 114 can establish connections with the computing devices over a network. To do so, the communicator 114 can communicate with the computers across the network. In one example, the communicator 114 can transmit syn packets to the computers (or the computers can transmit syn packets to the communicator 114) and establish the connections using a transport layer security (TLS) handshaking protocol. The communicator 114 can use any handshaking protocol to establish connections with the computers. In one example, the communicator 114 can establish a first connection with the computing device 104 and/or a second connection with the computing device 106. The communicator 114 can communicate with the computing devices 104 and/or 106 via the established connections.

The communicator 114 can be used to establish communication sessions with other computing devices or computing systems. For example, the communicator 114 can be an application programming interface (API) or application that can establish video calls or audio calls (or communication sessions) with other computing devices. Such calls can be or include conference calls, video calls, audio calls, etc., between users of different computing devices, such as the computing devices 104, 106, and/or 134. The communicator 114 can manage or facilitate such communication sessions such that users of the computing devices 104, 106, and/or 134 can communicate with each other through connections that the communicator 114 establishes with each of the computing devices 104, 106, and/or 134.

The communicator 114 can transmit messages to computing devices via different communication channels and/or using different communication protocols. For instance, the communicator 114 can transmit push notifications or other types of messages to computing devices by communicating with applications executing on the computing devices over a data channel (e.g., via the Internet, via a Wi-Fi channel, via a wireless LAN channel, etc.). The communicator 114 can additionally or instead transmit messages using different applications, such as by transmitting electronic mail (emails) to computing devices. The communicator 114 can transmit emails using an electronic account of the data processing system 102. The communicator 114 can transmit messages to computing devices in any way.

The data collector 116 can be structured as a set of instructions or logic that is executed by one or more servers or processors (e.g., the processing circuit 108), in some embodiments. The logic of the data collector 116 may be separate from the communicator 114 and, as such, separately executed and implemented. The data collector 116 can be configured to collect or obtain data files. The data files can be recordings of communication sessions, transcripts of recordings of communication sessions, notes or text describing or regarding communication sessions, and/or any other description or type of data regarding communication during communication sessions. The data files can include natural language content (e.g., words, phrases, comments, etc.) indicating spoken language during the communication session or not taken from the communication session.

The data collector 116 can receive and/or generate such data files regarding different communication sessions over time. In one example, the data collector 116 can receive a data file regarding a communication session after the data file is uploaded to the platform provided by the data processing system 102. In another example, the data collector 116 can generate a data file by monitoring a communication session. For instance, the data processing system 102 can record a communication session over the course of the communication session. Responsive to detecting the end of the communication session, the data collector 116 can stop the recording. The recording itself can be a data file. In some cases, the data collector 116 can convert the recording to a transcript containing the words spoken during the communication session. The data collector 116 can do so using a transcription service configured for speech-to-text transcription, such as by using feature extraction and/or pattern matching from a set of training data. In one example, the data collector 116 can use Fourier transforms to generate spectrograms from the spoken words that map to different words or phrases to generate the transcript. The data collector 116 can generate transcripts and/or recordings of communication sessions in memory over time. In cases in which the data files contain notes or descriptions of data files, the data collector 116 may receive the data files from the computing devices that were a part of the communication sessions and/or from different computing devices.

The data collector 116 can collect or receive data regarding application features. Application features can be or include products and/or services offered (i.e., offerings such as promotions, deals, etc.) by the provider entity 128, which may be embodied as and/or provided as software add-ins, plug-ins, etc. The offerings may be account configurations that can be activated for accounts with the data processing system 102. For example, the account configurations can include, for example, a configuration that enables creating deals for properties that are only available to members of the platform (e.g., member only deals), a configuration that enables assigning certain properties to only be accessible to certain members with the platform, a configuration that causes listings to appear or receive priority to appear at the top of certain search results, a configuration to price match listings with matching listings on other platforms or websites, a configuration that that enables deals to specific to users accessing the platform via a mobile device, a configuration that can recommend certain listings or properties to certain users, a configuration that enables updates to rates and availability, set restrictions, and maintain up-to-date inventory, etc. Such application features can correspond to or be associated with the platform provided by the data processing system 102. For example, an entity 130 may have an account with the data processing system 102. Through the account, the entity 130 can activate different application features. The entity 130 can do so based on selections and/or inputs a user of the entity 130 provides to the platform provided by the data processing system 102.

The data regarding application features that the data collector 116 can collect can be or include articles, descriptions, and/or specifications regarding the application features. Such data can include text describing different aspects, features, and/or characteristics of the application features. The data collector 116 can collect or receive such data from computing devices that upload the data to the platform provided by the data processing system 102. The data collector 116 can store the data in the database 126 upon receiving the data with associations with identifications of the application features with which the application features correspond.

The data collector 116 can collect or receive text strings regarding or corresponding to the application features. The text strings can be numerical, alpha, numeric, and/or alphanumeric values or descriptions regarding the use of one or more of the application features by different entities 130. For example, an entity 130 may activate, subscribe, and/or otherwise use an application feature with the account the entity 130 has with the data processing system 102. The application feature may correspond to providing or provisioning the entity 130 access to particular content or information provided and maintained by the data processing system 102, such as to have prioritized content or to cause content relating to the entity 130 appear at the top of a list and/or be the first to appear on a user interface. For example, if a user 132 searches for specific cruises in the Mediterranean via the computing device 134, an application feature purchased by the entity 130 may cause cruise listings provided by the entity 130 to appear on the top of a list of cruises that the data processing system 102 generates based on the search. After the entity 130 activates the feature, the entity 130 and/or the data collector 116 can monitor the performance of the entity 130's account with the application feature activated. In doing so, the data collector 116 can detect user interactions by users with content posted by or associated with the entity 130 on the platform.

User interactions can be any interactions that users perform with content or listings that are posted on the platform provided by the data processing system 102. Examples of such user interactions can include, but are not limited to, clicks, viewing time, comments, reviews, likes, etc. For instance, one type of user interaction can be a number of user selections of listings posted on the platform by an entity 130. Another type of user interaction can be the amount of time a user views specific listings posted on the platform or that a thumbnail image for the listing remains on the user's user interface (based on the page being displayed and a timer tracking the amount of time that the particular page is displayed). Another type of interaction can be positive or negative reviews of the listing. Another type of interaction can be a number of comments and/or likes that listings receive. Another type of interaction can be purchases or conversions of the listings. The interactions can be or include any type of interaction.

The different types of interactions can be affected by application features (offerings, such as products and/or services) that can be activated via the data processing system 102. For example, interaction types such as clicks, viewing time, and purchases may be positively impacted by an application feature that causes listings to appear at the top of search results that the data processing system 102 provides. In another example, interaction types such as occupancy rates and improved guest experienced can be improved by an application feature that offers specific deals to users accessing the platform via a mobile device or that are members with the platform.

The data collector 116 can monitor the user interactions using counters and/or timers. For example, the data collector 116 can maintain a separate counter for entity 130. The data collector 116 can monitor clicks on content posted by the entities 130 by incrementing the counters maintained for the entities 130 at each instance that a user 132 selects content or a listing posted by the entity 130 associated with the counter. The data collector 116 can similarly maintain and/or increment counters for other metrics, such as listing purchases, purchase amounts, listing upgrades, nights booked, etc. In another example, the data collector 116 can use a timer to monitor lengths of time in which users 132 view postings of content and/or listings by the entities 130.

The data collector 116 can maintain and increment the timers as the user views the content or listings and/or as the user views the pages associated with such content and/or listings. For example, the data collector 116 can determine when a user 132 is viewing a listing on a search results page based on messages that the computing device 134 of the user sends to the data processing system 102. The data collector 116 can increment a timer associated with the entity 130 that posted the listing at set intervals, such as every second. The data collector 116 can continually increment the timer as users 132 similarly view postings by the entity 130 on search results page to maintain a record of the amount of time users are viewing the content or listings posted by the entity on the search results page. The data collector 116 can increment multiple timers for different entities 130 when the user views multiple content or listing postings on the search results page. In instances in which the same entity posted multiple content or listing postings that are presented on the same search results page, the data collector 116 can either multiply the increments by the number of postings that are on display or only increment the counter once at the set intervals, depending on the embodiment. The data collector 116 can similarly maintain and increment either the same or a different timer for times when users 132 view pages presented after selection of such content or listings.

In another example, the data collector 116 can use timers to determine whether users viewed content, listings, or pages for a time that satisfies one or more criteria. For example, in some cases, the data collector 116 can maintain and increment timers for separate instances in which a user 132 view a page, content, or listing posted by the entities 130. The data collector 116 can determine when the users 132 respectively stop viewing the page, content, and/or listings (e.g., by scrolling or selecting a different page of the platform), such as based on messages or signals from the computing devices the users 132 or using cookies that the data processing system 102 may place on the browsers or applications accessing the platform provided by the data processing system 102. The data collector 116 can compare a count or time of a timer with a threshold responsive to determining a user 132 has stopped viewing a page, content item, or listing. Responsive to determining the count or time exceeds the threshold based on the comparison, the data collector 116 can determine a positive user interaction. Otherwise, the data collector 116 can determine a negative user interaction. The data collector 116 can increment a first counter for an entity that posted the page, content, or listing responsive to determining a positive interaction or a second counter for the entity responsive to determining a negative interaction. The data collector 116 can similarly increment counters for different entities 130 over time to maintain records of how the postings by the entities 130 are performing on the platform.

The data collector 116 can monitor such user interactions for the entities 130 before and/or after the entities 130 activate and/or access the application features of the platform. For example, the data collector 116 can maintain a record of the number and/or types of user interactions users have on the platform with content posted by or associated with individual entities 130. The data collector 116 can maintain separate records for time periods before and/or after the entities 130 activate particular application features. In doing so, the data collector 116 can generate records that can be compared to determine changes in user interactions between the time periods before and/or after the activation of the application features for separate entities 130.

The data collector 116 can generate text strings for individual application features and/or the entities 130 that activate and/or use the application features. The data collector 116 can do so for a particular application feature and entity 130 that activated the application feature by comparing the user interaction data in the records generated before and/or after the entity 130 activated or began using the application feature. For example, the data collector 116 can compare the number of clicks of particular content (e.g., video and/or text describing a listing) posted by the entity 130 received before activating an application feature with the number of clicks content posted by the entity 130 received after the application feature was activated.

For instance, the data collector 116 can monitor the number of selections of a particular rental home listings posted by the entity 130 for five month time periods before and after the entity 130 activates a members-only deal application feature with the entity 130's account. The members-only deal application feature can be setting in which users or travelers seeking to purchase a listing from the platform provided by the data processing system 102 can gain access to specific deals if they have a membership with the platform). The data collector 116 can do so by maintaining and incrementing a counter for the entity for each selection of a rental home listing by a user via the platform. For example, the data collector 116 can maintain and increment a first counter for the five month time period before the application feature is activated. The data collector 116 can maintain and increment a second counter for the five month time period after the application feature is activated. The data collector 116 can compare the counts of the two counters. Based on the comparison, the data collector 116 can generate a metric indicating a magnitude of the change in number of clicks between the two time periods. The magnitude can be a total increase or a percentage increase, for example. The data collector 116 can generate a text string including the determined value and/or a description of what the value means. In one example, the text string can be “Application feature A caused a 20% increase in conversions in content posted by Entity A.” The data collector 116 can generate text strings that include such metrics using templates and filling in variables or blanks in the templates with the relevant information (e.g., the name of the application feature, the generated metric, and/or the name of the relevant entity for which the metric was calculated), for example. The data collector 116 can generate such text strings in any way. In some cases, the text strings can be uploaded by a computing device to the platform and the data collector 116 can identify text strings. The data collector 116 can store the text strings in the database 126.

The database 126 can be a relational, non-relational, graph, and/or any other type or style of database (e.g., repository for information) that is configured to store data relating to different application features and/or entities 130 (e.g., entities 130 that have accounts with the platform hosted and/or provided by the data processing system 102). The database 126 can be stored in the processing circuit 108, can be stored separately from the processing circuit 108, and/or can be communicably coupled with the processing circuit 108. The database 126 can include a single database or the data processing system 102 may store and/or manage multiple databases that store the respective data described herein as being stored in the database 126. The database 126 can store individual records (e.g., files, tables, data structures, etc.) for individual application features. The records can include text strings generated for application features associated with the records. In some cases, the records can include identifiers of the entities 130 associated with the text strings (e.g., the entities 130 based on which user interaction data was used to generate the metrics of the text strings).

The database 126 or one or more other databases of the data processing system 102 can store other types of data. For example, the database 126 can store data (e.g., articles, descriptions, and/or specifications) regarding the application features. In some cases, the database 126 can store such data in data structures that specifically correspond to the application features. The database 126 can store such data in the records that correspond to the application features (e.g., the same records as the records in which the text strings are stored). In another example, the database 126 can store data files for different communication sessions. The database 126 can store the data files in records that specifically correspond to the communication sessions based on which the data files were generated. In some cases, the database 126 can store the data files in records that correspond with specific entities 130. For example, the database 126 can include records for accounts of or that otherwise correspond with entities 130 and communication interactions (e.g., communication sessions) of the entities 130. The database 126 can store any other data in the records, such as timestamps of the communication sessions. The data collector 116 can store any of such data in the database 126 upon receiving and/or generating the data.

The data (e.g., information such as articles, descriptions, and/or specifications) regarding the application features can be stored in the database 126 and can be stored with embeddings representing the data. For instance, the data processing system 102 can feed or input the data regarding the application features into the machine learning model 122 and execute the machine learning model 122 to cause the machine learning model 122 to generate an embedding for each piece of data (e.g., each article, description, and/or specification) and/or an embedding for the collection of the data regarding each application feature. Accordingly, the data processing system 102 can generate at least one embedding for each application feature based on the data stored in the database 126 for each application feature. The database 126 can store the data for each application feature with the embedding or embeddings generated for each respective application feature such that the embeddings may be used to query, retrieve, and/or identify the data for the application features.

The machine learning model 122 can be or include at least one generative machine learning model, such as a large language machine learning model, a small language model, a transformer, a deep neural network, etc., or any other type of machine learning model. The machine learning model 122 can be configured to receive as inputs of one or more types of content, such as text, audio, and/or video. The data processing system 102 (e.g., using the task agent 118) can execute the machine learning model 122 based on the inputs to generate outputs that correspond with the inputs. For example, the data processing system 102 can input a query requesting a certain type of data and execute the machine learning model 122. Based on the execution, the machine learning model 122 can apply learned weights and/or parameters to generate a response, in some cases using retrieval augmented generation to retrieve data from the database 126 to generate and output a response. It should be understood that while only one machine learning model is shown, in other embodiments, the data processing system 102 can include more than one machine learning model for use to perform the process described herein. In some cases, a different machine learning model can be executed to perform each step of the processes described herein.

As shown, the machine learning model 122 may be stored, retrieved, executed, and accessed by the data processing system 102 directly. However, in other embodiments, the machine learning model 122 or multiple other machine learning models that the data processing system 102 uses to perform the processes described herein are managed by, owned by, and/or otherwise associated with third parties relative to the provider institution that is associated with the data processing system 102. The third parties may be machine learning technology companies that specialize in the development and deployment of machine learning models, such as large language models (LLMs). In other embodiments, the third parties may be any third-parties that provide and allow access to computing programs, such as algorithms and other tools (e.g., LLMs). In cases in which the machine learning model 122 is stored remote from the data processing system 102, the data processing system 102 can execute the machine learning model 122 by transmitting a request or message containing an input or prompt to the computing system hosting the machine learning model 122 and the computing system can execute the machine learning model 122 using the input or prompt to generate an output and transmit the output back to the data processing system 102.

When transmitting recordings and/or transcripts of communication interactions for processing via a remote machine learning model, the data processing system 102 can redact certain types of information from the recordings and/or transcripts, such as personal identifiers (e.g., social security numbers and/or credit card numbers), surnames, and/or email addresses. For example, the data processing system 102 can store predefined keywords and/or phrases. The keywords can be or include flags of words to identify for removal from any outgoing transmissions. For instance, the keywords can include identifiers of personally identifiable information, such as social security numbers, addresses, etc. The keywords can additionally or instead include identifiers of protected health information, such as medical results and/or medical records. The data processing system 102 can identify such keywords from data files and redact the keywords and/or the data associated with the keywords from the data files prior to transmitting the data files to any third-parties.

The task agent 118 can be structured as a set of instructions or logic that is executed by one or more servers or processors (e.g., the processing circuit 108), in some embodiments. The task agent 118 can be or include a computer model, such as a large language model or another generative model, and/or code to execute other applications and/or perform different processes. For example, the task agent 118 can be a large language model-based software program that facilitates using one or more large language models to perform tasks. The task agent 118 can be configured to execute and/or use the data collector 116, the filtering service 120, the machine learning model 122, and/or the message router 124 to perform the processes described herein.

The task agent 118 can be configured to initiate the process of generating a context-specific message for an entity 130a (e.g., a first entity) regarding an application feature. The task agent 118 can do so based on data files generated for or from one or a plurality of communication sessions. For example, the task agent 118 can receive or obtain one or more data files (e.g., files including videos, voice recordings, text transcriptions, and/or notes) generated based on one or more communication interactions with the first entity 130a. The communication interactions may be or include one or multiple communication sessions that users or individuals of the entity 130a had with users or individuals of the provider entity 128 maintaining the data processing system 102, for example. The communication sessions may have been hosted over connections established between the data processing system 102 and the computing devices of the entity 130a. In some cases, the communication interactions can be in-person (e.g., in-person meetings or conferences). The task agent 118 can retrieve the data file or data files for the entity 130a (e.g., the data files regarding one or more communication interactions in which an individual of the entity 130a was involved) from the database 126. The task agent 118 can feed or input the data files or the content of the data files into the machine learning model 122 to initiate the process of generating a context-specific message for the entity 130a.

The task agent 118 can feed or input the data files or the content of the data files in the machine learning model 122 and execute the machine learning model 122 to cause the machine learning model 122 to generate an output indicating one or more objectives. The objectives can be objectives for the entity 130a, such as business objectives, goals, and/or targets for the entity 130a. In one example, the objectives can be to optimize revenue, improve occupancy rates, improve conversion rates, obtain increased clicks or views of the third-party's application features (i.e., increased web traffic to their third-party's content of, e.g., product and/or service offerings), and/or enhance guest experiences. The machine learning model 122 can be trained or fine-tuned to output such objectives based on data files and/or the task agent 118 can include text in a prompt with the data files with instructions to generate the objectives. The machine learning model 122 can apply trained weights and/or parameters on the input to output one or more objectives based on the execution of the machine learning model 122. The machine learning model 122 can output any number of objectives based on a single input.

The task agent 118 can identify an application feature based on the objectives output by the machine learning model 122. To do so, the task agent 118 can feed the objectives back into the machine learning model 122 (or a separate machine learning model) and execute the machine learning model 122. The machine learning model 122 can be trained and/or fine-tuned to generate identifications of application features based on input objectives and/or the task agent 118 can feed the objectives back into the machine learning model 122 in a prompt that includes instructions to output identifications of application features based on the objectives. The task agent 118 can execute the machine learning model 122 based on the objective input.

Responsive to the execution of the machine learning model 122 with the objective input, the machine learning model 122 can use RAG techniques to query the database 126 to generate an identification of an application feature. For example, the machine learning model 122 can encode or convert the objective input into an embedding (e.g., an objective embedding). The embedding can be or include a numerical embedding or vector with any number of dimensions. The machine learning model 122 can query the database 126 using the embedding, such as by comparing the embedding to the embeddings generated for each of the application features (e.g., the embeddings generated from the data of the application features). The machine learning model 122 can determine a similarity between the embedding and the stored embeddings for the application features by comparing the embedding with the stored embeddings and determining differences between the embedding and the stored embeddings. In some embodiments, the machine learning model 122 can determine the similarities using a cosine similarity technique. For instance, the machine learning model 122 can determine the similarities by determining angles between the embedding (e.g., embedding vector) generated from the objective input and the stored embeddings (e.g., stored embedding vectors). The similarities can be inversely proportional to the determined angle (e.g., higher angles can correspond to lower similarities and lower angles can correspond to higher similarities). The machine learning model 122 can generate similarities between the embedding generated from the input and the stored embeddings. The machine learning model 122 can identify one or a defined number of the embeddings with the highest similarities and identify the application features that correspond with the identified embeddings. The machine learning model 122 can generate or identify an identification of an application feature of each of the identified embeddings and output the identifications of the application features.

In some embodiments, instead of or in addition to using objectives to identify or generate identifications of application features, the task agent 118 can use RAG techniques based on the natural language content of the one or more data files of the entity 130a. For example, the task agent 118 can feed the content of the data files into the machine learning model 122 with or without objectives of the entity 130a with instructions to generate identifications of one or more application features. The machine learning model 122 can generate an embedding based on the input and compare the embedding with the embeddings stored for individual application features, as described above. Based on the comparison, the machine learning model 122 can identify or generate one or a defined number of application features that have the highest similarity to the input embedding and output identifications of the identified application features.

The task agent 118 can use the identification or identifications of the application features to identify one or more text strings stored in the database 126. For example, the task agent 118 can query the database 126 using the identification of the application feature as a key. Based on the query, the task agent 118 can identify a record that corresponds with the application feature from the database 126. The task agent 118 can retrieve text strings from the record to use to generate a message regarding the application feature.

In some embodiments, the task agent 118 can filter the retrieved text strings from the record to use to generate a message regarding the application feature. The task agent 118 can do so using the filtering service 120. For example, the filtering service 120 can be structured as a set of instructions or logic that is executed by one or more servers or processors (e.g., the processing circuit 108), in some embodiments. The logic of the filtering service 120 may be separate from the communicator 114, the data collector 116, and/or the task agent 118 and, as such, may be separately executed and implemented. The filtering service 120 can be configured to generate a filtered set of one or more text strings to use to generate a message regarding an application feature. The filtering service 120 can filter the text strings by identifying text strings that correspond with entities 130 that are similar to the entity 130a for which the data processing system 102 is generating the message. The filtering service 120 can identify one or more text strings that correspond with one or more (e.g., a defined number of) entities 130 that are similar to the entity 130a, and the filtered text strings can be used to generate a message for the entity 130a.

To filter the text strings, the filtering service 120 (e.g., based on the execution by the task agent 118) can identify one or more characteristics of the entity 130a. The characteristics can be or include aspects of the entity 130a, such as a size (e.g., number of members or employees), location, whether the employees work remote, revenue, debt-to-equity ratio, total value of assets, profit margin, market share, industry classification, number of patents, production capacity, number of locations, type of product or service, etc. Such characteristics can be stored for different entities 130, including the entity 130a, in separate records for entities 130 in the database 126. The records can be records for the accounts of the entities 130. The filtering service 120 can identify the characteristics of the entity 130a for which the filtering service 120 is generating the message from the record stored in the database 126.

The filtering service 120 can identify the characteristics of the entities 130 that correspond with the text strings extracted or identified from the database 126. For example, the filtering service 120 can identify the entities 130 that correspond with each of the identified text strings for the message. The filtering service 120 can identify the records in the database 126 for each of the identified entities 130. The filtering service 120 can identify or extract the characteristics from each of the identified records from the database 126.

The filtering service 120 can determine similarities between the entity 130a for which the message is being generated and the identified entities 130 based on the characteristics of the respective entities 130. To do so, the filtering service 120 can compare the characteristics of the entity 130a for which the message is being generated with the characteristics of each of the identified entities 130. The comparisons can cause the filtering service 120 to determine a separate similarity between the entity 130a for which the message is being generated and each of the identified entities 130. The filtering service 120 can determine the similarities based on a number of matching characteristics (e.g., characteristics that exactly match or are within a threshold of each other (e.g., such as number of employees between entities 130 that are within a defined range of each other)) or by converting the sets of characteristics of each entity 130 and using cosine similarity techniques, as described herein. The filtering service 120 can determine similarities between the entity 130a for which the message is being generated and entities 130 that correspond with identified text strings.

The filtering service 120 can identify one or more entities 130 based on the determined similarities. The filtering service 120 can do so based on the similarities satisfying one or more criteria. For example, the filtering service 120 can identify a defined number of one or more entities 130 determined to have the highest similarities with the entity 130a for which the data processing system 102 is generating the message. In another example, the filtering service 120 can compare the similarities to a threshold (e.g., a defined threshold). The filtering service 120 can identify entities 130 that correspond with similarities that exceed the threshold. In another example, the filtering service 120 can identify entities 130 with similarities that satisfy both such criteria. The filtering service 120 can identify entities 130 with similarities that satisfy any criteria.

For example, the filtering service 120 can be configured to determine similarities between entities 130 based on a number of matching characteristics the entities 130 share. For instance, the characteristics of the entity 130a can include fewer than 500 employees, a limited liability company, and incorporation in Delaware. The characteristics of the entity 130b can include greater than 500 employees, a limited liability company, and incorporation in Indiana. The characteristics of the entity 130c can include fewer than 500 employees, a limited liability company, and incorporation in Arizona. The filtering service 120 can determine the similarity between the entity 130a and the entity 130b to be one-third or 0.33, and the similarity between the entity 130a and the entity 130c to be two-thirds or 0.66. The filtering service 120 can identify the entity 130c based on the entity 130c having a higher similarity then the entity 130b and/or based on the entity 130c having a similarity exceeding a threshold (e.g., 1.5 or 0.6).

In another example, the filtering service 120 can be configured to determine similarities between entities 130 using cosine similarity techniques. For instance, the entities 130a-c can have the characteristics as described above. The filtering service 120 can convert the characteristics of each entity 130a-c into a separate embedding or vector. The filtering service 120 can do so, for example, by converting the characteristics of each entity 130a-c into numerical values in a multi-dimensional vector. The filtering service can do so, for example, using a stored mapping that maps characteristics to numerical values. Different characteristics can correspond to different values in the mapping. The filtering service 120 can compare the characteristics of each of the entities 130a-c to the mapping to identify values that correspond to the characteristics and generate embeddings with the values. The embeddings can include the values at locations or index values in the vectors that correspond to specific types of characteristics (e.g., the first index value can correspond to a number of employees, the second index value can correspond to a type of organization, and the third index values can correspond to a state of incorporation). In some cases, the filtering service 120 can execute the machine learning model 122 using the characteristics as input to generate separate embeddings in a vector space in which the machine learning model 122 is trained to generate vectors. The filtering service 120 can then use the following equation to separately determine the similarities between the embedding or vector generated from the characteristics of the entity 130a and similarly generated embeddings or vectors generated for the entities 130b and 130c:

$$cosine similarity ( A , B ) = ( \frac{A \cdot B}{‖ A ‖ ‖ B ‖} )$$

where A·B is the dot product of vectors A and B, and ∥A∥ and ∥B∥ are the magnitudes of vectors A and B, respectively. The filtering service 120 can determine the similarity between the entity 130a and the entity 130b and the similarity between the entity 130a and the entity 130c in this manner. The filtering service 120 can identify the entity 130c based on the entity 130c having a higher similarity then the entity 130b and/or based on the entity 130c having a similarity exceeding a threshold (e.g., 0.6).

The filtering service 120 can identify or select text strings retrieved for the application feature based on the identified entities 130. For example, the filtering service 120 can identify the text strings that correspond with the application feature and that correspond with the entities 130 that correspond with the satisfied criteria. The filtering service 120 can do so based on the identifications of entities 130 with stored associations with the text strings. The identified text strings can be filtered text strings. In this way, the filtering service 120 can filter text strings identified for the message to identify text strings that fit the context of the message that the data processing system 102 is generating, reducing the hallucinations that may be included in the message.

The task agent 118 can generate a message using the filtered text strings. For example, the task agent 118 can input an identification of the application feature, an identification of the entity 130a, and/or the filtered text strings into the machine learning model 122. The task agent 118 can execute the machine learning model 122 based on the input. The execution can cause the machine learning model 122 to generate or output a representation, such as a visual, audio, and/or audiovisual output representation, of the input. The machine learning model 122 can output the representation of the input as a textual representation in text form (e.g., as one or more paragraphs, formatted as an email, formatted as a notification, a summary, a report, bullet points, etc.) with a format and/or syntax that is readable to humans that follows grammatical rules configured or trained into the machine learning model 122. Other representations of the input that the machine learning model 122 can output or generate can include an audio-only output (e.g., speech synthesis, music compositions, podcasts, etc.,), a visual-only output (e.g., images, videos, drawings, digital art, text, etc.), and/or a combination of audio, visual and/or textual output (e.g., a video with text overlays, virtual characters that can speak, video tutorials, on-screen text instructions, etc.). The machine learning model 122 can generate the representation to include the filtered text strings and/or the identification of the application feature. In some cases, the machine learning model 122 can additionally include the identification of the entity 130a in the representation.

In some embodiments, the task agent 118 can customize the output representation of the input depending on the type of communication channel of transmission of the message. For example, the message router 124 may be configured to generate a message as an electronic message that can be transmitted to an electronic account of the entity 130a. The task agent 118 can identify the configuration (e.g., from the memory 112). The task agent 118 can include an identification of the electronic message format in the input to the machine learning model 122 to cause the machine learning model 122 to generate a output representation that is specific to electronic messages. The task agent 118 can similarly include identifications of any other types of communication channels, such as push notifications and/or chat messages, in inputs to cause the machine learning model 122 to generate output representations of the inputs that are tailored to the communication channels in which the messages containing the output representations will be transmitted. The machine learning model 122 may do so based on the trained weights and/or parameters of the machine learning model 122. In some cases, the machine learning model 122 may have been trained to generate messages specific to each communication channel such that the machine learning model 122 can take the input identifications of the communication channels into account when generating the messages. In some cases, the machine learning model 122 can be configured to use a template specific to the communication channel when generating representation to cause the representation to follow custom colorways and/or design elements. The templates may be updated by an administrator to personalize the messages that the representations the machine learning model 122 generates.

In some embodiments, when generating the representation of the input, the machine learning model 122 can reformulate (e.g., reformat) the text strings included in the input. For example, the machine learning model 122 can receive a text string that gives a metric such as “Application feature A caused a 20% increase in conversions in content posted by Entity A” as input. The machine learning model 122 can receive another text string indicating that “Entity A experienced an increased occupancy rate by 40% for six months following the adoption of application feature A.” Instead of placing the two text strings in the representation as is, the machine learning model 122 can combine the two text strings into a single sentence, such as “Using application feature A caused a 20% increase in conversions in content posted by Entity A and an increased occupancy rate by 40% over six months.” The machine learning model 122 can do so by applying weights and/or parameters of the machine learning model 122 to the input and such that the message follows rules (e.g., words and/or character limits) of the respective types of communication channels. The machine learning model 122 can similarly combine or change text strings in any manner to generate the message in a human-readable format while maintaining the context of the message.

The task agent 118 can use the message router 124 to generate and route a message containing the output representation to a computing device of the entity 130a. For example, the message router 124 can be structured as a set of instructions or logic that is executed by one or more servers or processors (e.g., the processing circuit 108), in some embodiments. The message router 124 can generate (e.g., based on an execution by the task agent 118) a message including the representation of the input. The message can have a format of an electronic message, a push notification, a chat message, etc. The format can be a configuration of the message router 124 or the data processing system 102. The message router 124 can generate the message by packaging the representation into the configured format. The message router 124 can transmit the generated message to the computing device of the entity 130a for which the message was generated. The computing device can display or present the contents of the message on a user interface.

By generating the message in the aforementioned manner with objectives and/or filtered text strings, the data processing system 102 can reduce the amount of “guesses” regarding different application features that the machine learning model 122 may include in the message. Instead, the machine learning model 122 can include contextually-specific text strings (e.g., text strings regarding a determine application that are specific to the entity 130a for which the machine learning model 122 is generating the message) in the message without using the processing resources of fine-tuned training or extra pre-processing of data. The data processing system 102 can reduce any hallucinations that the machine learning model 122 may include in the message by reducing the determinations or predictions that the machine learning model 122 may generate when generating the message.

In some cases, the message router 124 can transmit the message to the computing device by first identifying a destination for the message. The destination can be an electronic account and/or a particular computing device of the entity 130a. The electronic account can be an email account, for example. The particular computing device of the entity 130a can be a computing device of the entity 130a to which the message router 124 is configured to transmit messages and/or a computing device that stores or maintains an application to which the message router 124 is configured to transmit messages. The message router 124 can identify the destination by identifying an identifier of the electronic account or computing device from the database 126. For instance, the database 126 can store identifiers for different entities 130. The database 126 can store the identifiers in the records for the entities 130. The identifiers can include electronic account identifiers (e.g., email addresses), phone numbers, IP addresses, MAC addresses, account identifiers (e.g., identifiers of accounts of the entities 130), etc. The message router 124 can identify an identifier for the entity 130a as any of such identifiers. The message router 124 can transmit or send the message to the computing device of the entity 130a using the identifier (e.g., by placing the identifier for the entity 130a in the header of the message and routing the message to the computing device of the entity 130a with the identifier). In cases in which the message is a push notification, the message router 124 can transmit the message to the account of the entity 130a to cause the message to generate a push notification at the computing device of the entity 130a through the application or API associated with or configured to communicate with the data processing system 102. The computing device of the entity 130a can receive the message and present the message on a user interface, either or automatically or in response to a user input.

In one example, the data processing system 102 can generate a context-specific message for a particular communication session. For example, the data collector 116 can detect a termination of a communication session with at least one user device associated with the entity 130a. The data collector 116 can detect the termination of the communication session because the data processing system 102 may have been hosting the communication session and/or the communication session may have been accessed by a connection established between the data processing system 102 and the at least one user device. The data collector 116 can detect the termination of the communication session by determining, receiving, and/or identifying one or more communication session ending events, such as by: detecting a connection of the communication session being terminated or dropped; detecting inactivity or a timeout period elapsed without activity from a device connected for the communication session; detecting a user-initiated termination, such as a user pressing a “disconnect” or “end call” button; detecting a network failure and/or interruption that disrupts or causes the communication session to fail; detecting an application error that causes the application or software managing the communication session to fail; detecting a device participating in the communication session powered off; detecting a defined duration of the communication session has ended; detecting a user associated with the communication session is no longer available or response; receiving a notification from one of the computing devices involved in the communication session indicating a termination of the communication; etc.

Responsive to detecting the termination of the communication session, the data collector 116 can determine or identify a recording or a transcript of a recording of the communication session. For example, the data processing system 102 may have been recording the communication session during the course of the communication session. The data processing system 102 may label the recording with an identifier of the communication session. The data collector 116 can identify the recording based on the identifier of the communication session responsive to detecting the termination of the communication session. In some cases, the data collector 116 can generate a transcript from the recording and identify the transcript. The record and/or transcript can include natural language content as audio or as text, respectively.

In some embodiments, the data collector 116 can record and store the recording of a communication session without detecting the termination of the communication session. The recordings may occupy space in the database 126. In some embodiments, the data collector 116 can detect the termination of the communication session using one or more of the termination detections described above. The data collector 116 can automatically transcribe a recording generated for the communication session responsive to detecting the termination of the communication session (based on identifying the termination detection). The data collector 116 can store the transcription in the database 126 without storing the recording itself, thus freeing storage space in the database 126. Using the termination detection as a triggering event, only certain recordings are transcribed which may save space.

The task agent 118 can determine one or more objectives for the entity 130a. The task agent 118 can do so by inputting the record or the transcript of the recording of the communication session into the machine learning model 122 and executing the machine learning model 122. Based on the execution, the machine learning model 122 can output one or more objectives for the entity 130a.

In some embodiments, the execution of the machine learning model 122 can cause the machine learning model 122 to output an identification of the entity 130a. For example, the machine learning model 122 may be trained to parse the data of the transcript or recording to identify names of different entities 130. The machine learning model 122 may be trained or configured to identify an entity 130 for which to generate a message for the communication session. The machine learning model 122 may generate confidence values or scores for different names of entities 130 identified in the transcript or recording. The machine learning model 122 can determine the confidence scores based on the context in which the names were mentioned. For example, if an individual introduces that he/she is employed with a particular organization, the machine learning model 122 can identify the introduction context and assign a high confidence score to the name of the organization for the transcript or recording. The machine learning model 122 can dynamically adjust the confidence scores for different entities 130 as more words are spoken by different individuals over the course of the communication session. The machine learning model 122 can generate or output the identification of the entity 130 that corresponds with the highest confidence score.

In some cases, the machine learning model 122 can adjust or generate the confidence score depending on the computing device or speaker from which the words originated. For instance, the machine learning model 122 may assign a higher weight to an external computing device that is not associated with or owned by the provider that owns or hosts the data processing system 102 when the external computing device provides input introduction language from an individual that introduces that they are employed with a particular organization than if the language originated from a computing device that is associated with or owned by the provider of the data processing system. The machine learning model 122 can determine where the language originated based on labels in the transcript indicating the computing device from which the language originated and/or based on the inflection in the words (e.g., the machine learning model 122 may determine the words were spoken by an outside individual because the machine learning model 122 had not heard processed voice data of the voice or inflection of the individual before).

The task agent 118 can use the machine learning model 122 to determine an application feature. For example, the task agent 118 can input the objectives into the machine learning model 122 and execute the machine learning model 122. Based on the execution, the machine learning model 122 can use RAG techniques to identify one or more application features that correspond with the objectives, such as by determining application features that correspond with stored embeddings that are the most similar to an embedding of the input objectives. The machine learning model 122 can output the one or more application features identified as corresponding to the objectives.

In some embodiments, the task agent 118 can iteratively execute the machine learning model 122 to generate the objectives. For example, the task agent 118 can initially execute the machine learning model 122 using the recording or transcript as input to generate an identification of the entity 130a. Responsive to doing so, the task agent 118 can query the database 126 using the identification of the entity 130a to identify data files stored in the database 126 that correspond with the entity 130a. The task agent 118 can feed the recording or transcript for the communication session and/or the retrieved data files into the machine learning model 122 and execute the machine learning model 122 to generate objectives for the entity 130a.

The task agent 118 can retrieve one or more text strings that correspond to the application feature. For example, the task agent 118 can query the database 126 using the identification of the application feature to retrieve a record with the application feature. The task agent 118 can identify the record and retrieve text strings corresponding to the application feature from the record.

The task agent 118 can use the filtering service 120 to filter the text strings identified or extracted from the record. In doing so, the filtering service 120 can first identify characteristics of the entity 130a. The filtering service 120 can identify the characteristics of the entity 130a from the record containing information about the entity 130a in the database 126. The filtering service 120 can compare the characteristics of the entity 130a with characteristics of other entities 130 associated with the text strings (e.g., entities 130 based on which the text strings were generated). The filtering service 120 can identify one or more entities 130 that satisfy a similarity criterion based on the comparison. The filtering service 120 can identify the text strings that are associated with the identified one or more entities 130. The filtering service 120 can discard or remove from temporary memory any text not identified by the filtering service 120.

The task agent 118 can use the filtered text strings to generate a message to transmit to a computing device of the entity 130a. For example, the task agent 118 can input the filtered text strings, the identification of the entity 130a, and/or the identification of the application feature into the machine learning model 122. The task agent 118 can execute the machine learning model 122 based on the input to cause the machine learning model 122 to generate a representation of the input, as described herein. The task agent 118 can use the message router 124 to package the representation output (e.g., representation of the input) into a message configured to be transmitted to the computing device of the entity 130a via a communication channel with which the task agent 118 is configured to transmit messages. The computing device can be the same computing device that communicated over the communication session that terminated to initiate this process or a different computing device of the entity 130a.

In some cases, the task agent 118 can further personalize the message for the entity 130a. The task agent 118 can do so based on characteristics of the entity 130a. For example, the task agent 118 can feed the characteristics of the entity 130a into the machine learning model 122 as input. The machine learning model 122 may be trained to format messages generated for entities 130 based on characteristics of the entities 130. For instance, the machine learning model 122 may be trained to generate more personal messages for entities 130 with fewer members or employees than for entities 130 with more members or employees. The machine learning model 122 may adjust the format, tone, number of words, etc., based on characteristics of the entity 130a for which the machine learning model generates the representations. Accordingly, the task agent 118 including the characteristics of the entity 130a in the input into the machine learning model 122 can cause the machine learning model 122 to adjust or otherwise take the characteristics into account when generating the representation for the entity 130a.

In some cases, the task agent 118 can include key points (e.g., data) generated from the communication session in the message that is transmitted to the computing device of the entity 130a. For example, in some embodiments, the task agent 118 can include objectives that the machine learning model 122 generated for the entity 130a (e.g., from the recording or transcript of the communication session and/or any other data files) in the input to the machine learning model 122 to generate the representation. The machine learning model 122 can include the objectives with the filtered text strings, the identification of the application feature, and/or the identification of the entity 130a in the representation. In another example, the task agent 118 can execute the machine learning model 122 to cause the machine learning model 122 to generate a summary or a bulleted list describing the discussion of the communication session. The task agent 118 can include the summary or the bulleted list in the input to generate the representation of the input with the other features or components described above.

In some embodiments, the task agent 118 only includes the key points in the message and does not include text strings and/or an application feature in the representation of the communication session. For example, the task agent 118 can execute the machine learning model 122 to generate key points of the communication session based on the transcript or recording of the communication session. The task agent 118 can package the generated key points in a message and transmit the message to a computing device of the entity 130a. Because the task agent 118 may generate such a message automatically responsive to detecting the termination of the communication session, the task agent 118 can reduce any latency that may be involved in generating follow-up messages for the communication sessions.

An example of a representation (e.g., a visual representation) that the machine learning model 122 can generate based on a transcript is shown in FIG. 1B. In FIG. 1B, a transcript 136 and a representation 138 are shown, according to an example embodiment. The transcript 136 can be a text reproduction of a discussion between an individual and an agent of the provider entity 128 in which agent of the provider entity 128 recommends an “automatic rate match” application feature to the customer. The agent recommends that the customer activate the automatic rate match application feature in the platform. The discussion may occur over a communication session between a computing device of the provider entity 128 and a computing device of the individual, such as via a video call or an audio call. The data collector 116 can generate the transcript 136 by recording the discussion and then transcribing the recording, for example. The task agent 118 can generate the representation 138 of the transcript 136 by feeding the transcript 136 into the machine learning model 122. The task agent 118 can execute the machine learning model 122 to generate key points in a summary of the transcript 136. The machine learning model 122 can generate the summary in an email format.

The message router 124 can transmit or send the representation 138 to the computing device of the individual. The message router 124 can do so, for example, by identifying an email address of an electronic account associated with the computing device from the database 126. The message router 124 can identify the email address from the database 126 by identifying the account associated with the individual. The message router 124 may identify the account associated with the individual from the number or device identifier of the computing device that participated in the communication session and using the number or device identifier with a look-up technique in the database 126 to identify a record that stores data for the account. The message router 124 can identify the record and retrieve the email address from the record. The message router 124 can populate, package, or include the representation 138 in an email. The message router 124 can transmit or send the email to the electronic account of the individual (e.g., an email account associated with an email address), thus following up with the individual to send a summary of the communication session between the agent of the provider entity 128 and the individual. The representation 138 can be presented on a user interface shown on a display 140 of the computing device the individual uses to view the representation 138.

In some embodiments, instead of automatically transmitting the message to email account of the individual, the message router 124 can transmit the message to an email account of an internal user device or account of an internal user (e.g., the agent that participated in the communication session) of the data processing system 102. For example, the message router 124 can transmit an email to the account of the internal user. The internal user can edit the email as desired. The internal user can then send the edited email to the email account of the individual that participated in the communication session.

For example, referring now to FIG. 1C, an example user interface 142 showing an example electronic message generated using the systems and methods described herein is shown, according to some implementations. The data processing system 102 can present the user interface 142 at the computing device 104 of the provider entity 128 responsive to generating an electronic message identifying an accelerator tool application feature for a third-party entity 130 as described herein. In some embodiments, a pop-up overlay 146 may appear when a user is accessing the platform provided by the data processing system 102. For example, the data processing system 102 can identify one or more text strings to include in a message to send to the computing device 106 of the third-party entity 130 as described herein. The data processing system 102 can generate an electronic message using the text strings by inputting the text strings into the machine learning model 122. The data processing system 102 can transmit, through a connection through which the data processing system 102 is providing the platform accessed by the user, the electronic message to the computing device 104. The computing device 104 can receive the electronic message and present the contents of the electronic message in the pop-up overlay 146.

The pop-up overlay 146 can include an email interface. The email interface can match or be similar to an interface through which users can draft and send emails. For example, the pop-up overlay 146 can include a body portion 148 and a heading portion 150. The computing device 104 can automatically populate the body portion 148 with the contents of the electronic message received from the data processing system 102. The contents can include text strings 155 selected for the message in bold or in any other format (e.g., bold (as shown), italicized, highlighted, a combination of such changes, etc.) that can differentiate the text strings 155 from the other portions of the content of the message (which may not be emphasized or may otherwise be in a different format). The machine learning model 122 can include such formatting in the message the machine learning model 122 generates. The emphasis or differences in format can highlight to a reader the contextually selected text strings 155 for the message. The contents can include (e.g., also include) a selectable button 152 that, upon or responsive to selection, automatically causes the computing device 104 at which the button 152 was selected to present a different screen through which a user can activate the accelerator tool application feature for their account. The heading portion 150 can include fields or forms at which a user can input destination information (e.g., electronic account addresses that will receive the electronic message) and/or a subject line. A user accessing the pop-up overlay 146 can edit the electronic message by updating the content of the body portion 148 and the heading portion 150 by adding, removing, or otherwise changing text in the respective portions 148 and 150. The user can select a send button 154 on the pop-up overlay 146 to cause the electronic message to be sent to the electronic accounts associated with the third-party entity 130 represented or identified in the heading portion 150.

In some embodiments, instead of a pop-up overlay, the contents of the pop-up overlay 146 can be displayed in an email application configured to transmit electronic messages. For example, the contents of the message can be transmitted to an electronic account of a user of the provider entity 128. The user can access the electronic account through the email application. The user can edit or update the contents of the message and select an option to send the updated message to a recipient. Accordingly, by implementing the techniques described herein, the data processing system 102 can automatically generate contextual messages that a user can view and edit before sending off to the final destination.

In another example, referring now to FIG. 1D, an example user interface 156 showing a list of recommendations of application features, according to some implementations. The data processing system 102 can present the user interface 156 at the computing device 106 of the third-party entity 130 responsive to a selection by a user to view recommendations for application features to use to configure an account with the platform provided by the data processing system 102. For example, the user accessing the computing device 104 can select an option 158 to view recommendations for application features. Responsive to the selection, the data processing system 102 can present a list 160 of recommendations for application features that were generated for the third-party entity 130 associated with the user. The list 160 can include one or more application features that the data processing system 102 identified for the third-party entity 130 based on transcripts and/or recordings in which individuals of the third-party entity 130 participated, as described herein. The list 160 can include an identification of each application feature identified for the third-party entity 130 in visual representations generated by the data processing system 102 based on text strings and the identification of the respective application features. For example, the list 160 can include a visual representation 162 of a recommendation for a Member Only Deals application feature for the third-party entity 130 generated by the machine learning model 122 of the data processing system 102. In some embodiments, the visual representation 162 can be selectable to open a new page at which the user can activate the Member Only Deals application feature for the account of the third-party entity 130. Accordingly, by implementing the techniques described herein, the data processing system 102 can automatically generate contextual recommendations for application features that a user can use to configure their account with the data processing system 102.

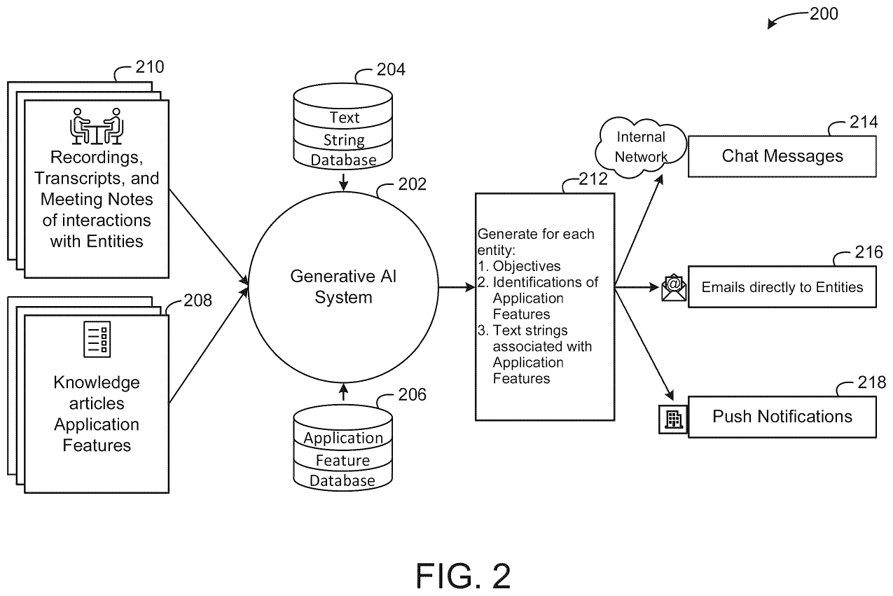

Based on the foregoing, referring now to FIG. 2, a block diagram of a sequence 200 for implementing a generative machine learning architecture for contextual message generation is shown, according to some implementations. The sequence 200 may be performed by one or more components of the system 100 as shown and described with reference to FIG. 1A. For example, the sequence 200 can be performed by the data processing system 102 and/or the computing devices 104, 106, and/or 134. In this regard, the generative AI system 202 may be the data processing system 102. Thus, the operations attributed to the generative AI system 202 herein may also be described as being performed by the data processing system 102. The sequence 200 may include any number of steps and the steps may be performed in any order. In some embodiments, certain of the processes of sequence 200 may be removed or omitted.

In the sequence 200, a generative AI system 202 can operate to generate messages to transmit to one or more computing devices. The generative AI system 202 can include one or more generative models (e.g., large language models, small language models, transformers, neural network, etc.) that can operate to automatically generate messages to transmit to computing devices based on communication interactions between users (e.g., internal users) of a provider entity associated with the generative AI system 202 and/or external users. The operations described herein with respect to the generative AI system 202 may, in turn, be attributed to the data processing system 102.

The generative AI system 202 can store a text string database 204 and an application feature database 206. The text string database 204 and the application feature database 206 can be separate (e.g., logically separate and/or physically separate) databases or be a part of the same database. The text string database 204 and/or the application feature database 206 can be a part of the database 126. The generative AI system 202 can store text strings for different application features in the text string database 204. The generative AI system 202 can store associations between the text strings and identifications of the entities for which the text strings were generated in the text string database 204 such that the text strings can later be identified and filtered for messages. The generative AI system 202 can store data and/or information regarding different application features in the application feature database 206. For example, the generative AI system 202 can receive data and/or documents 208 and store the data and/or documents 208 in the application feature database 206. The generative AI system 202 can store the data and/or documents with identifications of the application features to which the data and/or documents correspond or describe. In some cases, the generative AI system 202 can generate embeddings (e.g., application feature embeddings) from the data and/or documents of the respective application features and store the embeddings in the application feature database 206. Such embeddings can later be used to aid in identifying the application feature to identify in a message based on a communication session.

The generative AI system 202 can identify one or more data files 210 regarding communication sessions and/or communication interactions for a first entity. The first entity can be a third-party entity, such as one of the entities 130, shown and described with reference to FIG. 1A. The data files 210 can include transcripts, recordings, meeting notes, etc., of communication sessions or communication interactions that correspond with the first entity (e.g., that involve computing devices and/or users associated with or under the umbrella of the first entity). The data files 210 can include communication interactions with any number of entities. The generative AI system 202 can identify such data files for the first entity responsive to detecting a communication session with a computing device associated with the first entity has ended or terminated, responsive to an input request, responsive to determining an end to a defined time period since a previous message was generated and/or transmitted to the first entity, etc. The generative AI system 202 can input the data files 210 regarding the first entity into a machine learning model (e.g., the machine learning model 122) using a task agent (e.g., the task agent 118) and execute the machine learning model to generate one or more objectives for the first entity.

The generative AI system 202 can use the objectives to identify at least one application feature. For example, the generative AI system 202 can use the task agent to execute the machine learning model with the objectives. Based on the execution, the machine learning model can use RAG techniques to query the application feature database 206. In doing so, the machine learning model can generate an embedding of the input objectives and compare the embedding to embeddings of the application features stored in the application feature database 206 and generated based on the data and/or documents 208 regarding the application features. The machine learning model may identify the application feature that is the most similar or most closely matches the objectives (e.g., the embedding generated from the objectives). The machine learning model may then output the identification of the application feature.

The generative AI system 202 can identify one or more text strings to include in the message to the computing device of the first entity. For example, the generative AI system 202 can use the task agent to query the text string database 204 for text strings that correspond to, or that were generated based on, the application feature. In doing so, the generative AI system 202 can retrieve or identify one or more text strings from the text string database 204.

The generative AI system 202 can filter the identified text strings. The generative AI system 202 can use the task agent to filter the identified text strings. The generative AI system 202 can do so based on the entities for which the text strings were generated. For example, the task agent can identify characteristics of the first entity. The task agent can identify the characteristics from one of the databases 204 and/or 206 or from a different database or data structure. The task agent can identify characteristics of entities associated with the text strings from the same location (e.g., database or data structure) as the first entity. The task agent can compare (e.g., using cosine similarity techniques) the characteristics of the first entity with the characteristics of the entities associated with the text strings. Based on the comparison, the task agent can identify one or a defined number of entities that are the most similar to the first entity. The generative AI system 202 can identify the text strings associated with the identified entities and discard the remaining text strings, thus generating a filtered set of one or more text strings.

The generative AI system 202 can generate an input prompt 212. The generative AI system 202 can generate the input prompt 212 using the task agent. The task agent can generate the input prompt 212 to include an identification of the first entity (e.g., which the generative AI system 202 can automatically determine based on the data files and/or determined based on a user input), the filtered text strings, the objectives, and/or the identification of the application feature. The task agent can feed the input prompt into the machine learning model and execute the machine learning model. The execution can cause the machine learning model to generate a representation of the input prompt, such as in a format determined based on a communication in which the representation will be transmitted.

The generative AI system 202 can generate and transmit a message containing the representation of the input prompt. The generative AI system 202 can generate the message by packaging the representation of the input prompt into a message in a format as configured by a user. The format can be a chat message format that can be transmitted via a chat communication channel 214 (e.g., an internal communication network of the provider of the generative AI system 202), an electronic message format that can be transmitted to an electronic account via an email channel 216, and/or a notification format that can be transmitted as a push notification through a data channel 218, such as to an application associated with or owned by the provider of the generative AI system 202 (e.g., an application through which the generative AI system 202 provides the platform). The generative AI system 202 can transmit the message to the computing device associated with the first entity over the channel for which the generative AI system 202 generated and/or formatted the message.

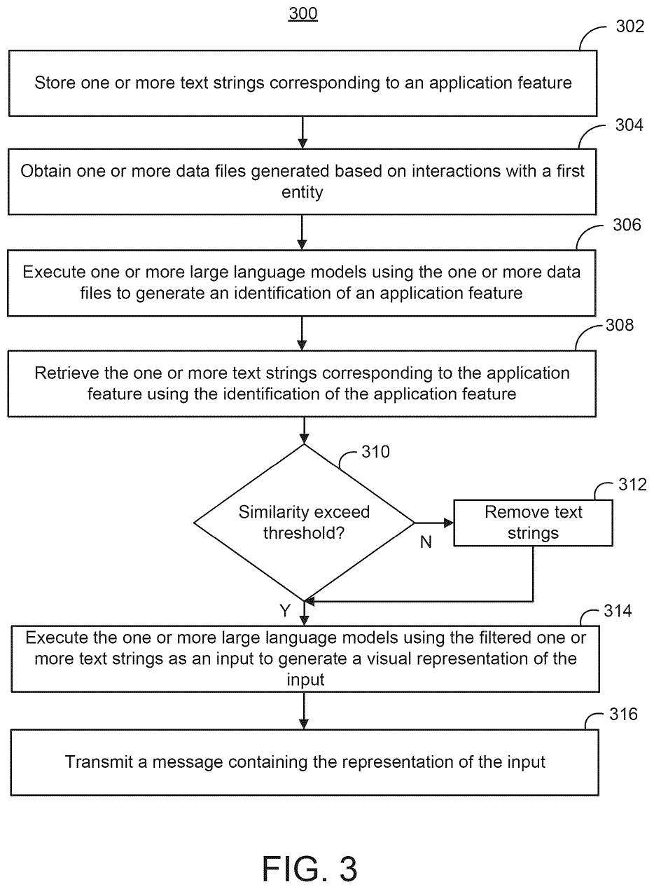

FIG. 3 is a flow chart of a method 300 for implementing a generative machine learning architecture for contextual message generation, according to some implementations. The method 300 may be performed by one or more of the data processing system 102, the computing devices 104, 106, and/or 134, the generative AI system 202, or any other computer or set of computers. The method 300 may include any number of steps and the steps may be performed in any order. The data processing system 102 may perform the method 300 to facilitate a contextual generation of messages by generative models while reducing hallucinations. It should be understood that in some embodiments, more processes may be performed, less processes may be performed (e.g., some steps of method 300 may be deleted), and still further some processes may be combined into a single process.

At step 302, the data processing system 102 can store one or more text strings that correspond to an application feature. The data processing system 102 can store the text strings in a database, such as with identifications of the entities with which the text strings are associated. Each text string can be or include a metric indicating how content of an associated entity performed (e.g., a number of user interactions with the content) when the entity had activated or used a corresponding application feature with a platform provided by the data processing system 102. In one example, a text string can indicate an increase or decrease in the number of clicks on content uploaded and/or posted by an entity to the platform after the entity activated or began using an application feature. The text string can include a numerical magnitude of the increase or decrease. The data processing system 102 can receive such text strings as input in a file containing one or more text strings for a particular application feature or for multiple application features. In some cases, the data processing system 102 can automatically generate the text strings by monitoring the performance of content posted by different entities before and/or after activating the different application features. The data processing system 102 can store and fill in templates or replace variables with values based on the monitoring of the user interactions with content posted on the platform. The data processing system 102 can receive and/or store text strings in any manner.

At step 304, the data processing system 102 can obtain one or more data files. The data files can be generated based on communication interactions with a first entity. The first entity can be an enterprise, a company, or an organization. The first entity can be a third-party entity, such as one of the entities 130, shown and described with reference to FIG. 1A. The data files can be or include recordings, transcripts, and/or notes generated from communication interactions (e.g., video calls or audio calls (e.g., communication sessions), in-person meetings, etc.) between individuals of the provider and one or more individuals of the first entity. The data processing system 102 can generate one or more of the data files, such as by recording and/or transcribing communication sessions with the first entity held through the platform provided by the data processing system 102, the data processing system 102 can receive one or more of the data files as a data upload from a computing device, or a combination of the two, to obtain the data files. The data processing system 102 can identify the data files that correspond with the first entity responsive to a user input, a time interval ending, or responsive to detecting the end or termination of a communication session with a computing device of the first entity.

At step 306, the data processing system 102 can execute one or more large language models using the one or more data files. The data processing system 102 can execute the one or more large language models using the one or more data files to generate an identification of an application feature. The data processing system 102 can do so using a task agent (e.g., the task agent 118). For example, the task agent can input one or more data files that correspond to a first entity into a large language model of the one or more large language models and execute the large language model. Based on the execution, the large language model can generate one or more objectives for the first entity. The objectives can be targets and/or goals of the first entity regarding content that the first entity posts on the platform provided by the data processing system 102.

The task agent can use the objectives to identify an application feature. To do so, the task agent can input the objectives into the same or a different large language model as the large language model that was used to generate the objectives. The task agent can execute the large language model based on the input to cause the large language model to generate an embedding from the objectives and perform RAG techniques to compare the embedding with stored embeddings for different application features (e.g., stored embeddings generated based on specifications and/or documents describing the application features) stored in a database. The task agent can identify an application feature that corresponds with an application feature that corresponds with a stored embedding with the highest similarity to the embedding generated from the input. The machine learning model can identify or generate an identification of the application feature that corresponds with the highest similarity and output the identification of the application feature.

At step 308, the data processing system 102 can retrieve one or more text strings that correspond to the application feature. The data processing system 102 can retrieve the one or more text strings using the task agent. The task agent can retrieve the one or more text strings using the output identification of the application feature generated by the large language model. For example, the task agent can query the database storing text strings for different application features using the identification of the application feature output by the large language model as a key. Based on the query, the task agent can identify text strings that correspond with the application feature, such as by identifying the record containing the identification of the application feature and text strings corresponding to the application feature. The task agent can retrieve the text strings from the identified record.

At step 310, the data processing system 102 can filter the text strings. The data processing system 102 can filter the text strings using the task agent. The task agent can filter the text strings by executing a filtering service. In doing so, the task agent can identify characteristics of the first entity. The characteristics can be or include different aspects of the first entity, such as size, organization type, location, type of product or service the first entity sells, etc. The task agent can identify the characteristics from a record stored in a database containing the characteristics of the first entity, such as a record containing account data for the first entity that includes such characteristics. The task agent can identify the entities that are associated with the identified text strings for the application feature. The task agent can similarly identify characteristics of the entities associated with the text strings from records generated for the entities.

The task agent can determine similarities between the characteristics of the first entity and characteristics of other entities associated with the text strings. The task agent can do so, for example, by encoding and/or otherwise generating embeddings for the set of characteristics for each entity and comparing the embedding of the first entity with the embeddings of the other entities associated with the text strings. The task agent can use cosine similarity techniques to determine the similarities between the embedding for the first entity and the embeddings of the other entities. For example, the first entity can have characteristics of a hotel, more than 2000 employees, a limited liability company, and an incorporation in Delaware. The task agent can convert such characteristics of the first entity into an embedding using a table containing mappings of characteristics to values or by encoding the characteristics (e.g., using a large language model) of the first entity. The task agent can similarly generate embeddings of the entities associated with the text strings. The task agent can use the following equation

$$cosine similarity ( A , B ) = ( \frac{A \cdot B}{‖ A ‖ ‖ B ‖} )$$

where A·B is the dot product of vectors A and B, and ∥A∥ and ∥B∥ are the magnitudes of vectors A and B, respectively. The task agent can determine separate similarities between the first entity and each other entity. In another example, the task agent can determine the similarities proportional to a number of matching characteristics between the first entity and the other entities. The task agent can compare the similarities to a threshold and/or with each other to determine entities that are the most similar and/or that are similar above a threshold with the first entity. In doing so, the task agent can determine entities for which to identify text strings to include in a message to transmit to a computing device of the first entity.

The task agent can filter the text strings retrieved for the application feature based on the entities that the task agent identified as being similar above the threshold and/or the most similar to the first entity. For example, for any text strings that do not satisfy such criteria, at step 312, the task agent can discard or remove the text strings from temporary memory (e.g., remove the text strings from consideration to use as input to generate the message). The task agent can identify the remaining text strings as filtered text strings to use to generate a message to the computing device of the first entity.

At step 314, the data processing system 102 can execute the one or more large language models using the filtered text strings as input. The data processing system 102 can do so using the task agent. For example, the task agent can input the filtered text strings, the identification of the application feature, and an identification of the first entity into one of the one or more large language models. In some embodiments, the task agent can use the same or a different large language model to the large language model that the task agent used for the previous steps. The task agent can execute the large language model based on the input to generate a representation (e.g., a visual representation, an audio representation, a textual representation, etc.) of the input. The representation can include the input data in a paragraph form or a form that is conducive for presentation via the communication channel through which the data processing system 102 will transmit a message containing the representation. In one example, the task agent can include an identification of the communication channel (e.g., electronic message, push notification, or chat message) as input with the other data. The large language model can format the representation according to the identification of the communication channel, such as by generating the representation to be smaller for push notifications and/or chat messages than for electronic messages.

At step 316, the data processing system 102 can generate and/or transmit a message containing the representation of the input. The data processing system 102 can generate the message by packaging the representation into the message in a format of the communication channel for which the data processing system 102 will transmit the message. The data processing system 102 can identify a destination to transmit or send the message, such as by identifying an electronic account or profile of the first entity that is configured to receive electronic messages and/or chat messages and/or a phone number or other device identifier of a mobile device or computing device that is configured to receive push notifications. The data processing system 102 can transmit the push notification to application executing on the mobile devices or computing devices that corresponds to or is an API of the data processing system 102. The data processing system can insert the identifier of the destination into a header of the message and use the header to transmit the message to the electronic account, profile, and/or computing device of the first entity. The computing device of the first entity can receive the message and present the message on a user interface.

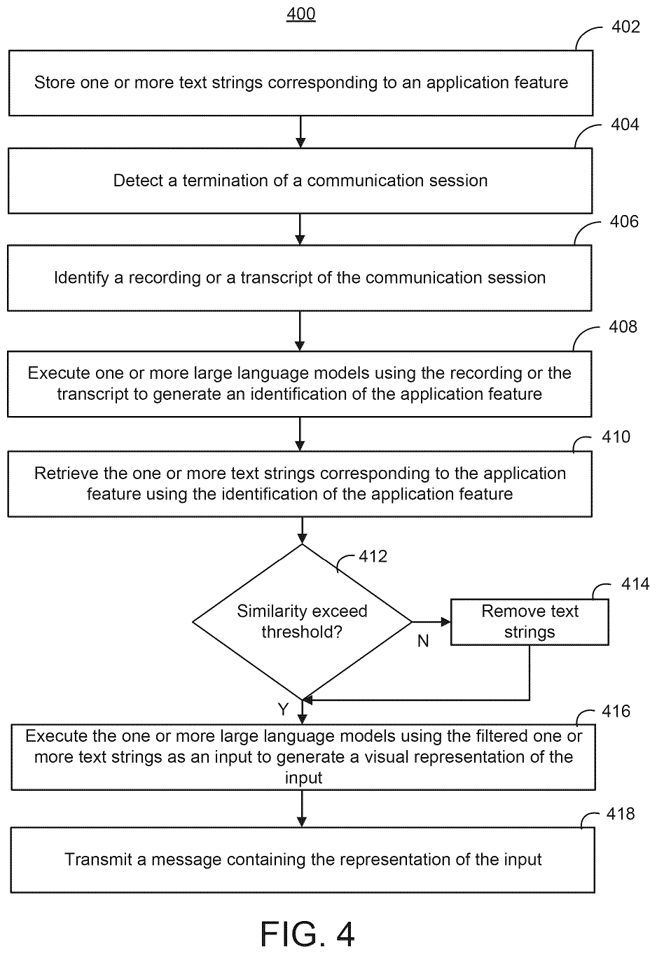

FIG. 4 is a flow chart of a method 400 for implementing a generative machine learning architecture for contextual message generation for a communication session, according to some implementations. The method 400 may be performed by one or more of the data processing system 102, the computing devices 104, 106, and/or 134, the generative AI system 202, or any other computer or set of computers. The method 400 may include any number of steps and the steps may be performed in any order. The data processing system 102 may perform the method 400 to facilitate automatic contextual generation of a message regarding a communication session by generative models while reducing hallucinations. It should be understood that in some embodiments, more processes may be performed, less processes may be performed (e.g., some steps of method 400 may be deleted), and still further some processes may be combined into a single process.

At step 402, the data processing system 102 can store one or more text strings corresponding to an application feature. The data processing system can store the text strings in the same or a similar manner to the manner described with reference to step 302 of FIG. 3.

At step 404, the data processing system 102 can detect a termination of a communication session. The communication session can be between the provider (e.g., an individual of the provider) that owns or operates the data processing system 102 and an individual of a first entity. The first entity can be an enterprise, a company, or an organization. The first entity can be a third-party entity, such as one of the entities 130, shown and described with reference to FIG. 1A. The communication session can be between the data processing system 102 and a computing device of the first entity or between a computing device owned or operated by the provider and the computing device of the first entity. In some cases, the communication session between the computing device of the first entity and the computing device of the provider may be hosted by the data processing system 102 (e.g., the data processing system 102 can establish connections with both computing devices and facilitate communication between the computing devices). The data processing system 102 can detect a termination of the communication session by determining one or both of the connections between the data processing system 102 and the computing devices of the provider and/or the first entity ended or terminated, by receiving a message from one of the computing devices indicating the termination, by detecting the end of the communication session, or through any other method. In some cases, the data processing system 102 may not host or be directly involved in the communication session. In such cases, the computing devices can communicate directly with each other in the communication session. One or both of the computing devices can transmit a message indicating the communication session has ended to the data processing system 102.

At step 406, the data processing system 102 can identify a recording or a transcript of the communication session. The recording may be generated by the data processing system 102 by recording the communication session during the course of the data processing system 102 or one or both of the computing devices may record the communication session. In cases in which one or both of the computing devices generate the recording, the computing devices can transmit the recording to the data processing system 102. In some cases, the data processing system 102 can transcribe the recording to generate and/or identify a transcript of the communication session.

At step 408, the data processing system 102 can execute one or more large language models using the recording or the transcript. The data processing system 102 can execute the one or more large language models to generate an identification of the application feature. The data processing system 102 can generate the identification of the application feature in the same or a similar manner to the manner described with reference to step 306 of FIG. 3. For example, the data processing system 102 can use a task agent to execute a large language model using the record or transcript of the termination communication session with the first entity and/or any other data files of the first entity. Based on the execution, the large language model can generate one or more objectives for the first entity. The task agent can input the objectives for the first entity back into the large language model or a different large language model. The task agent can execute the large language model based on the input to cause the large language model to use RAG techniques to generate an identification of the application feature.

At step 410, the data processing system 102 can retrieve the one or more text strings corresponding to the application feature. The data processing system 102 can retrieve the one or more text strings by using the identification of the application feature to query the database containing records for application features that contain or store the text strings associated with the application features. At step 412, the data processing system can filter the text strings by identifying text strings that correspond with entities that are the most similar or that are similar above a threshold with the first entity. At step 414, the data processing system 102 can remove or discard the text strings that are associated with entities that are not identified as being similar to the first entity at step 412. The data processing system 102 can perform steps 410-414 in the same or a similar manner to the manner described with reference to steps 308-312. The data processing system 102 can perform the steps 410-414 using the task agent.

At step 416, the data processing system 102 can execute the one or more large language models to generate a representation. The data processing system 102 can execute the one or more large language models using the task agent. For example, the task agent can input the filtered text strings, the identification of the application feature, and the identification of the first entity into the large language model that was used to perform any one of the previous steps of the method 400 or a different large language model. In some cases, the task agent can include objectives in the input. The task agent can execute the large language model based on the input. The execution can cause the large language model to generate a representation of the input. At step 418, the data processing system 102 can generate and/or transmit a message containing the representation to a computing device of the first entity. The data processing system 102 can generate and/or transmit the message using the task agent. The data processing system 102 can perform steps 416-418 in the same or a similar manner to the manner described with reference to steps 314-316.

In a non-limiting example, a user accessing the computing device 104 can initiate a communication session (e.g., a video call) with a user accessing the computing device 106. The user of the computing device 104 can be an individual associated with the provider entity, and the user of the computing device 106 can be an individual associated with a first entity (e.g., an external entity to the provider entity of the data processing system 102, such a third-party entity 130). The data processing system 102 can host the communication session such that the two users can communicate in the communication session via connections established through the data processing system 102. Over the course of the communication session, the two users may discuss business goals and/or targets. For example, the user of the first entity may express interest in seeking faster and more conversions with users that access the platform provided by the data processing system 102. The data processing system 102 can record the communication session using recording software. In some cases, the data processing system 102 can generate a transcript of the recording using transcription software.

The data processing system 102 can detect or determine when the communication session between the users ends. The data processing system 102 can do so by determining one or both of the computing devices 104 and/or 106 dropped the connections established with the data processing system 102, detecting inactivity or a timeout period elapsed without activity from a device connected for the communication session, detecting a user-initiated terminations, such as a user pressing a “disconnect” or “end call” button, detecting a network failure and/or interruption that disrupts or causes the communication session to fail, detecting an application error that causes the application or software managing the communication session to fail, detecting a device participating in the communication session powered off, detecting a defined duration of the communication session has ended, detecting the a user associated with the communication session is no longer available or response, etc. Responsive to detecting the termination of the communication session, the data processing system 102 can initiate a process to generate a follow-up electronic message to send to the computing device 106 or another computing device of the first entity.

To do so, the data processing system 102 can identify the first entity. The data processing system 102 can identify the first entity using one or more large language models that are stored in the memory 112 of the data processing system 102. For example, the data processing system 102 can execute the task agent 118 to cause the task agent 118 to feed the transcript or recording of the terminated communication session into the machine learning model 122. The task agent 118 can execute the machine learning model 122 to cause the machine learning model 122 to generate or output a name or identifier of the first entity. The data processing system 102 can identify the first entity in any way (e.g., such as by receiving the name or identifier of the first entity from a user input or automatically from the computing device 106).

The data processing system 102 can identify one or more objectives of the first entity. The data processing system 102 can identify the objectives using the task agent 118 and the one or more large language models. For example, the data processing system 102 can execute the task agent 118 to cause the task agent 118 to feed the recording or transcript of the recording into the machine learning model 122 or a different machine learning model. In some cases, the data processing system 102 can use the previously determined or identified identifier of the first entity to retrieve other stored recordings, transcripts, and/or meeting notes regarding the first entity from the memory 112 or the database 126. The task agent 118 can input the recording(s), transcript(s), and/or meeting note(s) regarding the first entity into the machine learning model 122 and execute the machine learning model 122. The execution can cause the machine learning model 122 to output one or more objectives (e.g., a target or objective to seek faster and more conversions) for the first entity.

The data processing system 102 can use the output objectives to identify an application feature. The data processing system 102 can identify the application feature using the task agent 118 and the one or more large language models. For example, the data processing system 102 can execute the task agent 118 to cause the task agent 118 to feed (e.g., input) the objectives into the machine learning model 122 or a different machine learning model. The task agent 118 can execute the machine learning model 122 to cause the machine learning model 122 to output an identification of an application feature (e.g., a software add-in, a plug-in, an application configuration that can be activated for accounts with the data processing system, a promotion feature, etc.). The task agent 118 can identify the output identification of the application feature.

The data processing system 102 can identify one or more text strings for the application feature. The text strings can be or include metrics indicating how the application affected the performance of content that different entities uploaded to the platform (e.g., website) hosted by the data processing system 102. The data processing system 102 can identify the one or more text strings using the task agent 118. For example, the task agent 118 can query the database 126 using the identification of the application feature output by the machine learning model 122. Based on the query, the task agent 118 can identify the record storing text strings for the application feature. The task agent 118 can identify, extract, or retrieve the text strings from the identified record.

The data processing system 102 can filter the one or more text strings. The data processing system can filter the one or more text strings using the task agent 118. The task agent 118 can filter the one or more text strings using the filtering service 120. For example, the task agent 118 can execute the filtering service 120 to cause the filtering service 120 to identify the entities to which each of the identified text strings associated with the application feature corresponds. The filtering service 120 can identify characteristics of the first entity and characteristics of each of the identified entities associated with the text strings. The filtering service 120 can compare the characteristics between the first entity and the identified entities. Based on the comparison, the filtering service 120 can identify one or more entities that satisfy a similarity threshold or criteria with the first entity. The filtering service 120 can identify one or more text strings that correspond with the entities that satisfy the similarity threshold or criteria to identify filtered one or more text strings to include in a message to generate and/or transmit to a computing device of the first entity.

The data processing system 102 can generate a visual representation to include in the message to the first entity. The data processing system 102 can generate the visual representation using the task agent 118 and the one or more large language models. For example, the data processing system 102 can execute the task agent 118 to cause the task agent 118 to feed the filtered text strings, the identification of the application feature, and/or the identification of the application feature into the machine learning model 122 or a different machine learning model. In some cases, the task agent 118 can include the objectives in the input into the machine learning model 122. The task agent 118 can execute the machine learning model 122 to cause the machine learning model 122 to output a visual representation of the input. In doing so, the machine learning model 122 can output the visual representation in a form or format based on the communication through which the data processing system 102 will transmit the message, such as based on an identification of the communication channel that the task agent 118 includes in the input and/or based on the training and/or configuration of the machine learning model 122.

An example of such a visual representation is as follows: “Dear Anna, I wanted to inform you that we have identified member only deals as a great application feature to achieve your main goal of maintaining high ADR while working on slow pacing. member only deals focuses on a particular type of deal offering that has shown to increase average daily rates of 13.0% compared to entities that do not use member only deals. By offering exclusive deals to loyalty members, we can attract and retain valuable customers during slower periods. To take advantage of this opportunity, please visit the following link. Let's work together to enhance our revenue and guest satisfaction. Best regards, John Doe.” As shown, the visual representation can include the goals (e.g., because the task agent 118 can include determined objectives in the input to the machine learning model 122 to generate the visual representation) and a text string indicating an increase in performance of 13 percent with the application feature.

The data processing system 102 can generate and transmit a message containing the visual representation. The data processing system 102 can do so using the task agent 118. For example, the task agent 118 can execute the message router 124 to cause the message router 124 to package the visual representation into a configured format for the message. The message router 124 can identify a destination for the message, such as by identifying an account identifier, profile identifier, or device identifier (e.g., phone number, MAC address, IP address, etc.) stored in a record associated with the user of the computing device 106. The message router 124 can insert the destination into a header or field of the message and transmit the message to the computing device 106 or another computing device associated with the entity. The message router 124 can transmit the message to the computing device 106 or another computing device of the first entity using the identifier. The computing device that receives the message can present the contents of the message on a user interface.

### B. Computing Environment

The systems discussed herein may be deployed as and/or executed on various types and forms of computing device, such as a computer, network device or appliance capable of communicating on any type and form of network and performing the operations described herein. FIGS. 5A and 5B depict block diagrams of a computing system 500 for practicing certain of the innovations described herein. In a non-limiting example, the computing system 500 may implement in any of the data processing system 102, the computing devices 104 and/or 106, or various other example systems and devices described in the present disclosure, such as any of the computing devices and/or computing systems described with respect to FIGS. 2, 3, and/or 4.

As shown in FIGS. 5A and 5B, each computing system 500 includes a central processing unit 521, and a main memory unit 522. As shown in FIG. 5A, a computing system 500 may include a storage device 528, an installation device 516, a network interface 518, an I/O controller 523, display devices 524a-524n, a keyboard 526 and a pointing device 527, such as a mouse. The storage device 528 may include, without limitation, an operating system and/or software. As shown in FIG. 5B, each computing system 500 may also include additional optional elements, such as a memory port 503, a bridge 570, one or more input/output devices 530a-530n (generally referred to using reference numeral 530), and a cache memory 540 in communication with the central processing unit 521.

The central processing unit 521 is any processing unit(s) that responds to and processes instructions fetched from the main memory unit 522. In many embodiments, the central processing unit 521 is provided by a microprocessor unit, such as: those manufactured by Intel Corporation of Mountain View, California; those manufactured by International Business Machines of White Plains, New York; or those manufactured by Advanced Micro Devices of Sunnyvale, California. The computing system 500 may be based on any of these processors, or any other processor capable of operating as described herein.

Main memory unit 522 may be one or more memory chips capable of storing data and allowing any storage location to be directly accessed by the microprocessor 521, such as any type or variant of Static random access memory (SRAM), Dynamic random access memory (DRAM), Ferroelectric RAM (FRAM), NAND Flash, NOR Flash and Solid State Drives (SSD). The main memory 522 may be based on any of the above described memory chips, or any other available memory chips capable of operating as described herein. In the embodiment shown in FIG. 5A, the processor 521 communicates with main memory 522 via a system bus 580 (described in more detail below). FIG. 5B depicts an embodiment of a computing system 500 in which the processor communicates directly with main memory 522 via a memory port 503. For example, in FIG. 5B the main memory 522 may be DRDRAM.

FIG. 5B depicts an embodiment in which the main processor 521 communicates directly with cache memory 540 via a secondary bus, sometimes referred to as a backside bus. In other embodiments, the main processor 521 communicates with cache memory 540 using the system bus 580. Cache memory 540 typically has a faster response time than main memory 522 and is provided by, for example, SRAM, BSRAM, or EDRAM. In the embodiment shown in FIG. 5B, the processor 521 communicates with various I/O devices 530 via a local system bus 580. Various buses may be used to connect the central processing unit 521 to any of the I/O devices 530, for example, a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 524, the processor 521 may use an Advanced Graphics Port (AGP) to communicate with the display 524. FIG. 5B depicts an embodiment of a computing system 500 in which the main processor 521 may communicate directly with I/O device 530b, for example via HYPERTRANSPORT, RAPIDIO, or INFINIBAND communications technology. FIG. 5B also depicts an embodiment in which local busses and direct communication are mixed: the processor 521 communicates with I/O device 530a using a local interconnect bus while communicating with I/O device 530b directly.

A wide variety of I/O devices 530a-530n may be present in the computing system 500. Input devices include keyboards, mice, trackpads, trackballs, microphones, dials, touch pads, touch screens, and drawing tablets. Output devices include video displays, speakers, inkjet printers, laser printers, projectors and dye-sublimation printers. The I/O devices may be controlled by an I/O controller 523 as shown in FIG. 5A. The I/O controller may control one or more I/O devices such as a keyboard 526 and a pointing device 527, e.g., a mouse or optical pen. Furthermore, an I/O device may also provide storage and/or an installation device 516 for the computing system 500. In still other embodiments, the computing system 500 may provide USB connections (not shown) to receive handheld USB storage devices such as the USB Flash Drive line of devices manufactured by Twintech Industry, Inc., of Los Alamitos, California.

Referring again to FIG. 5A, the computing system 500 may support any suitable installation device 516, such as a disk drive, a CD-ROM drive, a CD-R/RW drive, a DVD-ROM drive, a flash memory drive, tape drives of various formats, USB device, hard-drive, a network interface, or any other device suitable for installing software and programs. The computing system 500 may further include a storage device, such as one or more hard disk drives or redundant arrays of independent disks, for storing an operating system and other related software, and for storing application software programs such as any program or software 520 for implementing (e.g., configured and/or designed for) the systems and methods described herein. Optionally, any of the installation devices 516 could also be used as the storage device. Additionally, the operating system and the software can be run from a bootable medium.

Furthermore, the computing system 500 may include a network interface 518 to interface to a network through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, IEEE 802.11ac, IEEE 802.11ad, CDMA, GSM, WiMax and direct asynchronous connections). In one embodiment, the computing system 500 communicates with other computing devices 500′ via any type and/or form of gateway or tunneling protocol such as Secure Socket Layer (SSL) or Transport Layer Security (TLS). The network interface 518 may include a built-in network adapter, network interface card, PCMCIA network card, card bus network adapter, wireless network adapter, USB network adapter, modem or any other device suitable for interfacing the computing system 500 to any type of network capable of communication and performing the operations described herein.

In some implementations, the computing system 500 may include or be connected to one or more display devices 524a-524n. As such, any of the I/O devices 530a-530n and/or the I/O controller 523 may include any type and/or form of suitable hardware, software, or combination of hardware and software to support, enable or provide for the connection and use of the display device(s) 524a-524n by the computing system 500. For example, the computing system 500 may include any type and/or form of video adapter, video card, driver, and/or library to interface, communicate, connect or otherwise use the display device(s) 524a-524n. In one embodiment, a video adapter may include multiple connectors to interface to the display device(s) 524a-524n. In other embodiments, the computing system 500 may include multiple video adapters, with each video adapter connected to the display device(s) 524a-524n. In some implementations, any portion of the operating system of the computing system 500 may be configured for using multiple displays 524a-524n. One ordinarily skilled in the art will recognize and appreciate the various ways and embodiments that a computing system 500 may be configured to have one or more display devices 524a-524n.

In further embodiments, an I/O device 530 may be a bridge between the system bus 580 and an external communication bus, such as a USB bus, an Apple Desktop Bus, an RS-232 serial connection, a SCSI bus, a FireWire bus, a FireWire 500 bus, an Ethernet bus, an AppleTalk bus, a Gigabit Ethernet bus, an Asynchronous Transfer Mode bus, a FibreChannel bus, a Serial Attached small computer system interface bus, a USB connection, or a HDMI bus.

A computing system 500 of the sort depicted in FIGS. 5A and 5B may operate under the control of an operating system, which control scheduling of tasks and access to system resources. The computing system 500 can be running any operating system, such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to, Android, produced by Google Inc.; WINDOWS 7 and 8, produced by Microsoft Corporation of Redmond, Washington; MAC OS, produced by Apple Computer of Cupertino, California; WebOS, produced by Research In Motion (RIM); OS/2, produced by International Business Machines of Armonk, New York; and Linux, a freely-available operating system distributed by Caldera Corp. of Salt Lake City, Utah, or any type and/or form of a Unix operating system, among others.

The computing system 500 can be any workstation, telephone, desktop computer, laptop or notebook computer, server, database, handheld computer, mobile telephone or other portable telecommunications device, media playing device, a gaming system, mobile computing device, or any other type and/or form of computing, telecommunications or media device that is capable of communication. The computing system 500 has sufficient processor power and memory capacity to perform the operations described herein.

In some implementations, the computing system 500 may have different processors, operating systems, and input devices consistent with the device. For example, in one embodiment, the computing system 500 is a smart phone, mobile device, tablet or personal digital assistant. In still other embodiments, the computing system 500 is an Android-based mobile device, an iPhone smart phone manufactured by Apple Computer of Cupertino, California, or a Blackberry or WebOS-based handheld device or smart phone, such as the devices manufactured by Research In Motion Limited. Moreover, the computing system 500 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

The term “coupled,” as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

The implementations described herein have been described with reference to drawings. The drawings illustrate certain details of specific implementations that implement the systems, methods, and programs described herein. Describing the implementations with drawings should not be construed as imposing on the disclosure any limitations that may be present in the drawings.

It should be understood that no claim element herein is to be construed under the provisions of 35 U.S.C. § 52 (f), unless the element is expressly recited using the phrase “means for.”

As used herein, the term “circuit” may include hardware structured to execute the functions described herein. In some implementations, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some implementations, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. In a non-limiting example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some implementations, the one or more processors may be embodied in various ways. The one or more processors may be constructed in a manner sufficient to perform at least the operations described herein. In some implementations, the one or more processors may be shared by multiple circuits (e.g., circuit A and circuit B may comprise or otherwise share the same processor, which, in some example implementations, may execute instructions stored, or otherwise accessed, via different areas of memory). Alternatively or additionally, the one or more processors may be structured to perform or otherwise execute certain operations independent of one or more co-processors.

In other example implementations, two or more processors may be coupled via a bus to enable independent, parallel, pipelined, or multi-threaded instruction execution. Each processor may be implemented as one or more processors, ASICs, FPGAs, GPUs, TPUs, digital signal processors (DSPs), or other suitable electronic data processing components structured to execute instructions provided by memory. The one or more processors may take the form of a single core processor, multi-core processor (e.g., a dual core processor, triple core processor, or quad core processor), microprocessor, etc. In some implementations, the one or more processors may be external to the apparatus, in a non-limiting example, the one or more processors may be a remote processor (e.g., a cloud-based processor). Alternatively or additionally, the one or more processors may be internal or local to the apparatus. In this regard, a given circuit or components thereof may be disposed locally (e.g., as part of a local server, a local computing system) or remotely (e.g., as part of a remote server such as a cloud-based server). To that end, a “circuit” as described herein may include components that are distributed across one or more locations.

An exemplary system for implementing the overall system or portions of the implementations might include a general-purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile or non-volatile memories), etc. In some implementations, the non-volatile media may take the form of ROM, flash memory (e.g., flash memory such as NAND, 3D NAND, NOR, 3D NOR), EEPROM, MRAM, magnetic storage, hard disks, optical disks, etc. In other implementations, the volatile storage media may take the form of RAM, TRAM, ZRAM, etc. Combinations of the above are also included within the scope of machine-readable media. In this regard, machine-executable instructions comprise, in a non-limiting example, instructions and data, which cause a general-purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example implementations described herein.

It should also be noted that the term “input devices,” as described herein, may include any type of input device including, but not limited to, a keyboard, a keypad, a mouse, joystick, or other input devices performing a similar function. Comparatively, the term “output device,” as described herein, may include any type of output device including, but not limited to, a computer monitor, printer, facsimile machine, or other output devices performing a similar function.

It should be noted that although the diagrams herein may show a specific order and composition of method steps, it is understood that the order of these steps may differ from what is depicted. In a non-limiting example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative implementations. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps, and decision steps.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations may also be implemented in combination in a single implementation. Conversely, various features that are described in the context of a single implementation may also be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

Having now described some illustrative implementations and implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements, and features discussed only in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act, or element may include implementations where the act or element is based at least in part on any information, act, or element.

Any implementation disclosed herein may be combined with any other implementation, and references to “an implementation,” “some implementations,” “an alternate implementation,” “various implementation,” “one implementation,” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The foregoing description of implementations has been presented for purposes of illustration and description. It is not intended to be exhaustive or to limit the disclosure to the precise form disclosed, and modifications and variations are possible in light of the above teachings or may be acquired from this disclosure. The implementations were chosen and described in order to explain the principals of the disclosure and its practical application to enable one skilled in the art to utilize the various implementations and with various modifications as are suited to the particular use contemplated. Other substitutions, modifications, changes, and omissions may be made in the design, operating conditions and implementation of the implementations without departing from the scope of the present disclosure as expressed in the appended claims.

What is claimed is:

1. A computing system, comprising:
a network interface; and
at least one processing circuit coupled to the network interface, the at least one processing circuit comprising at least one processor and at least one memory, the at least one memory storing instructions therein that, when executed by the at least one processor, cause the at least one processor to:
store, in a database, one or more text strings corresponding to an application feature and generated based on the use of the application feature by at least one entity;
obtain, via the network interface, one or more data files each comprising natural language content and generated based on a different communication interaction with a first entity;
execute, using a task agent, one or more large language models using the natural language content of the one or more data files to generate an identification of the application feature determined for the first entity;
retrieve, using the task agent, the one or more text strings corresponding to the application feature from the database using the identification of the application feature;
filter, using the task agent, the one or more text strings based on at least one similarity between the first entity and at least one other entity associated with the one or more text strings;
execute, using the task agent, the one or more large language models using the filtered one or more text strings, the identification of the application feature, and an identification of the first entity as an input to generate a visual representation of the input; and
transmit a message for presentation at a computing device of the first entity, the message containing the visual representation of the input.

2. The computing system of claim 1, wherein the instructions, when executed by the at least one processor, further cause the at least one processor to obtain the one or more data files by:
establishing, via the network interface, a connection the computing device or another computing device of the first entity; and
generating a voice or video recording of spoken language over the established connection, wherein the instructions, when executed by the at least one processor, further cause the at least one processor to execute the one or more large language models using the natural language content of the one or more data files by executing the one or more large language models based at least on the voice or video recording of spoken language over the established connection.

3. The computing system of claim 1, wherein the instructions, when executed by the at least one processor, further cause the at least one processor to obtain the one or more data files by:
establishing, via the network interface, a plurality of connections each with at least one computing device of the first entity; and
generating a voice or video recording of spoken language over each of the plurality of established connections,
wherein the instructions, when executed by the at least one processor, cause the at least one processor to execute the one or more large language models using the natural language content of the one or more data files by executing the one or more large language models based at least on the voice or video recordings of spoken language over the plurality of established connections.

4. The computing system of claim 1, wherein the instructions, when executed by the at least one processor, further cause the at least one processor to execute the one or more large language models using the natural language content of the one or more data files to generate the identification of the application feature determined for the first entity by:
converting, using the one or more large language models, the natural language content of the one or more data files into one or more embeddings; and
generating, using the one or more large language models, the identification of the application feature based on a similarity between the one or more embeddings and an application feature embedding corresponding to the application feature.

5. The computing system of claim 4, wherein the instructions, when executed by the at least one processor, further cause the at least one processor to:
receive a text description of the application feature; and
execute the one or more large language models using the text description of the application feature to generate the application feature embedding corresponding to the application feature.

6. The computing system of claim 1, wherein the instructions, when executed by the at least one processor, cause the at least one processor to execute the one or more large language models using the natural language content of the one or more data files to generate the identification of the application feature for the first entity by:
executing, using the task agent, the one or more large language models using the natural language content to generate one or more objectives for the first entity; and
generating the identification of the application feature based on the one or more objectives for the first entity.

7. The computing system of claim 6, wherein the instructions, when executed by the at least one processor, cause the at least one processor to generate the identification of the application feature based on the one or more objectives by:
generating, using the one or more large language models, the identification of the application feature based on a similarity between the one or more objectives for the first entity and an application feature embedding corresponding to the application feature.

8. The computing system of claim 7, wherein the instructions, when executed by the at least one processor, cause the at least one processor to:
receive a text description of one or more feature objectives of the application feature; and
execute the one or more large language models using the text description of the one or more feature objectives of the application feature to generate the application feature embedding corresponding to the application feature.

9. The computing system of claim 1, wherein the instructions, when executed by the at least one processor, cause the at least one processor to filter the one or more text strings by:
compare, using the task agent, one or more characteristics of the first entity with corresponding characteristics of the at least one other entity associated with the one or more text strings;
determine, using the task agent, a similarity between the first entity and each of the at least one other entity based which on the one or more text strings were generated based on the comparison; and
select, using the task agent, the filtered one or more text strings based on the filtered one or more text strings corresponding to entities with a determined similarity satisfying at least one condition.

10. The computing system of claim 1, wherein the instructions, when executed by the at least one processor, further cause the at least one processor to execute the one or more large language models to generate the visual representation of the input by:
executing, using the task agent, the one or more large language models using as further input an identification of a communication channel of transmission of the message containing the visual representation of the input to the computing device.

11. The computing system of claim 1, wherein the instructions, when executed by the at least one processor, cause the at least one processor to execute the one or more large language models to generate the visual representation of the input by:
executing, using the task agent, the one or more large language models to generate a textual representation of the input including a reformulated version of the filtered one or more text strings and the identification of the application feature.

12. The computing system of claim 1, wherein the computing device is a first computing device, and wherein the instructions, when executed by the at least one processor, further cause the at least one processor to detect a termination of a communication interaction with a second computing device of the first entity;
wherein the instructions, when executed by the at least one processor, further cause the at least one processor to obtain the one or more data files by automatically identifying a recording or a transcript of the recording of the communication interaction with the second computing device of the first entity in response to detecting the termination of the communication interaction.

13. The computing system of claim 12, wherein the instructions, when executed by the at least one processor, further cause the at least one processor to execute the one or more large language models using data of or generated based on the recording or the transcript of the recording as further input to generate the visual representation to include one or more representations of the recording or the transcript.

14. The computing system of claim 1, wherein the instructions, when executed by the at least one processor, cause the at least one processor to execute the one or more large language models using one or more characteristics of the first entity as further input to generate the visual representation.

15. The computing system of claim 1, wherein the instructions, when executed by the at least one processor, cause the at least one processor to execute the one or more large language models using the natural language content of the one or more data files to generate an identification of the first entity with the identification of the application feature determined for the first entity.

16. A method, comprising:
storing, by one or more processors in a database, one or more text strings corresponding to an application feature and generated based on the use of the application feature by at least one entity;
obtaining, by the one or more processors, one or more data files each comprising natural language content and generated based on a different communication interaction with a first entity;
executing, by the one or more processors using a task agent, one or more large language models using the natural language content of the one or more data files to generate an identification of the application feature determined for the first entity;
retrieving, by the one or more processors using the task agent, the one or more text strings corresponding to the application feature from the database using the identification of the application feature;
filtering, by the one or more processors using the task agent, the one or more text strings based on at least one similarity between the first entity and at least one other entity associated with the one or more text strings;
executing, by the one or more processors using the task agent, the one or more large language models using the filtered one or more text strings, the identification of the application feature, and an identification of the first entity as an input to generate a visual representation of the input; and
transmitting, by the one or more processors, a message for presentation at a computing device of the first entity, the message containing the visual representation of the input.

17. The method of claim 16, wherein obtaining the one or more data files further comprises:
establishing, by the one or more processors, a connection with the computing device or another computing device of the first entity; and
generating, by the one or more processors, a voice or video recording of spoken language over the established connection,
wherein executing the one or more large language models using the natural language content of the one or more data files comprises executing, by the one or more processors, the one or more large language models based at least on the voice or video recording of spoken language over the established connection.

18. The method of claim 16, wherein executing the one or more large language models using the natural language content of the one or more data files to generate the identification of the application feature determined for the first entity further comprises:
converting, by the one or more processors using the one or more large language models, the natural language content of the one or more data files into one or more embeddings; and
generating, by the one or more processors using the one or more large language models, the identification of the application feature based on a similarity between the one or more embeddings and an application feature embedding corresponding to the application feature.

19. A computing system, comprising:
a network interface configured to communicate with at least one user device of a first entity; and
at least one processing circuit coupled to the network interface, the at least one processing circuit comprising at least one processor and at least one memory, the at least one memory storing instructions therein that, when executed by the at least one processor, cause the at least one processor to:
store, in a database, one or more text strings corresponding to an application feature and generated based on the use of the application feature by an entity;
detect a termination of a communication session with at least one user device associated with a first entity;
responsive to the detection, identify a recording or a transcript of the recording of the communication session with the at least one user device associated with the first entity, the recording or the transcript of the recording comprising natural language content;
execute, using a task agent, one or more large language models using the natural language content of the recording or the transcript of the recording to generate an identification of the application feature determined for the first entity;
retrieve, using the task agent, the one or more text strings corresponding to the application feature from the database using the identification of the application feature;
filter, using the task agent, the one or more text strings based on at least one similarity between the first entity and at least one other entity associated with the one or more text strings;
execute, using the task agent, the one or more large language models using the filtered one or more text strings, the identification of the application feature, and an identification of the first entity as input to generate a visual representation of the input; and
transmit a message for presentation at a computing device, the message containing the visual representation of the input.

20. The computing system of claim 19, wherein the instructions, when executed by the at least one processor, cause the at least one processor to execute the one or more large language models using data of or generated based on the recording or the transcript of the recording as further input to generate the visual representation to include one or more representations of the recording or the transcript.
